(19) United States
(12) Patent Application Publication
(10) Pub. No.: US 2026/0358778 A1
(43) Pub. Date: Nov. 12, 2026

(54) CONTROLLING OBJECTS USING AN IMAGE

(71) Applicant: Apple Inc., Cupertino, CA (US)

(72) Inventors: Yutaka Yokokawa, Los Gatos, CA (US); Amrutha Hakkare Arunachala, Sunnyvale, CA (US); Dimitris Ladopoulos, Sunnyvale, CA (US); Magnus H. Johnson, San Francisco, CA (US); Mahdi Azmandian, San Mateo, CA (US)

(21) Appl. No.: 19/661,777

(22) Filed: Apr. 29, 2026

Related U.S. Application Data
(60) Provisional application No. 63/800,609, filed on May 6, 2025.

(51) Int. Cl. G05B 19/02; G06T 5/50

(52) U.S. Cl. CPC G05B 19/02; G06T 5/50; G05B 2219/2642; G06T 2207/20221

(57) ABSTRACT

In one implementation, a method of changing a state of an object is performed by a device including a display, non-transitory memory, and one or more processors. The method includes obtaining an image of a physical environment including a plurality of objects. The method includes generating a respective plurality of associations between the plurality of objects and a plurality of portions of the image of the physical environment. The method includes saving, in the non-transitory memory, the image of the physical environment and the plurality of associations. The method includes displaying the image of the physical environment. The method includes, in response to receiving user input directed to a particular portion of the image of the physical environment of the plurality of portions of the image of the physical environment, causing a change in state of a particular object of the plurality of objects associated with the particular portion of the image of the physical environment by a particular association of the plurality of associations.

### CROSS-REFERENCE TO RELATED APPLICATIONS

This application claims priority to U.S. Provisional Patent App. No. 63/800,609, filed on May 6, 2025, which is hereby incorporated by reference in its entirety.

### TECHNICAL FIELD

The present disclosure generally relates to systems, methods, and devices for changing a state of an object.

### BACKGROUND

Many homes are equipped with so-called “smart” devices which have network connectivity and change states in response to receiving a command over the network. Various user interfaces may be displayed for facilitating the generation of such commands.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1N illustrate a first physical environment during a plurality of time periods in accordance with some implementations.

FIGS. 2A-2R illustrate a second physical environment during a plurality of time periods in accordance with some implementations.

FIG. 3 illustrates the first physical environment during a later time period in accordance with some implementations.

FIGS. 4A-4G illustrate the second physical environment with an alternative user interface during a plurality of time periods in accordance with some implementations

FIG. 5 is a flowchart representation of a method of changing a state of an object in accordance with some implementations.

FIG. 6 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for changing a state of an object. In various implementations, the method is performed by a device including a display, non-transitory memory, and one or more processors. The method includes obtaining an image of a physical environment including a plurality of objects. The method includes generating a respective plurality of associations between the plurality of objects and a plurality of portions of the image of the physical environment. The method includes saving, in the non-transitory memory, the image of the physical environment and the plurality of associations. The method includes displaying the image of the physical environment. The method includes, in response to receiving user input directed to a particular portion of the image of the physical environment of the plurality of portions of the image of the physical environment, causing a change in state of a particular object of the plurality of objects associated with the particular portion of the image of the physical environment by a particular association of the plurality of associations.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### Description

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

As noted above, many homes are equipped with so-called “smart” devices which have network connectivity and change states in response to receiving a command over the network. Various user interfaces may be displayed for facilitating the generation of such commands. For example, in various implementations, multiple devices within a home are assigned to different rooms and the user interface displays affordances for transmitting commands to devices within a particular room. In various implementations, the affordances for the devices may be presented in a grid or a list, each affordance including a name of the device.

However, in various implementations, multiple devices may have similar names and it may be difficult for a user to know which affordance would transmit a command to a particular device in the room. Accordingly, in various implementations, the user interface includes an image of the room with the affordances for each device presented over the portion of the image representing the device.

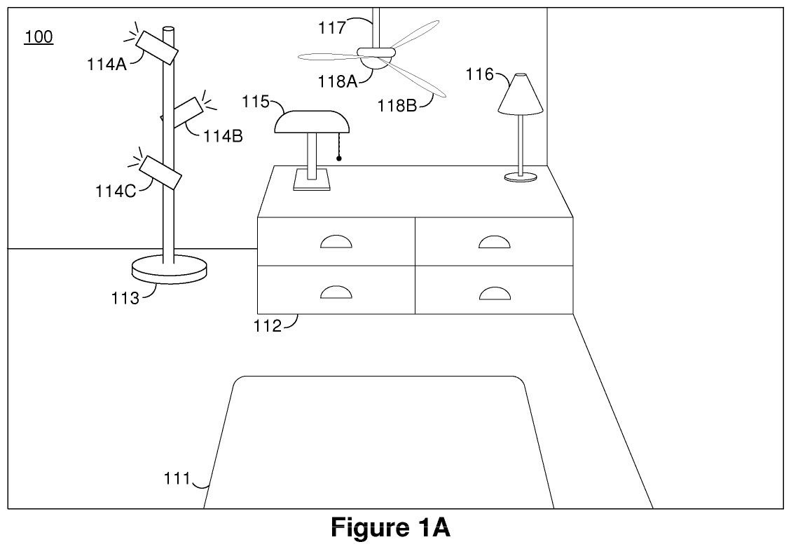

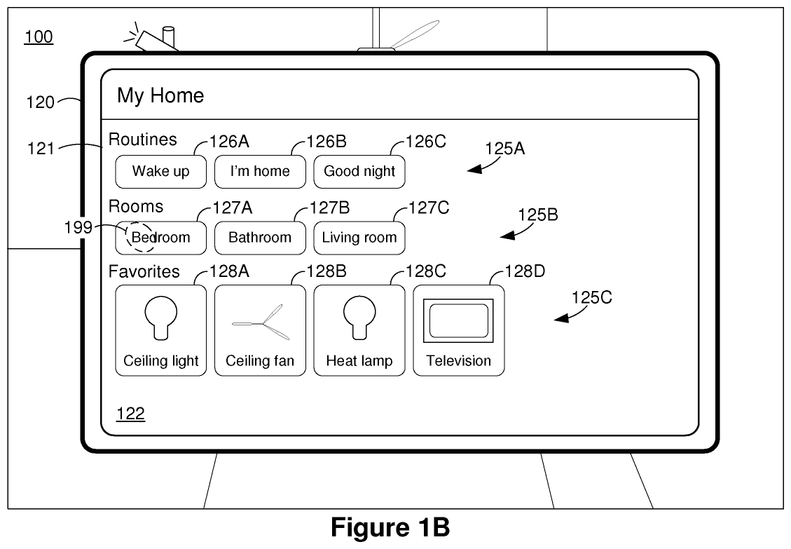

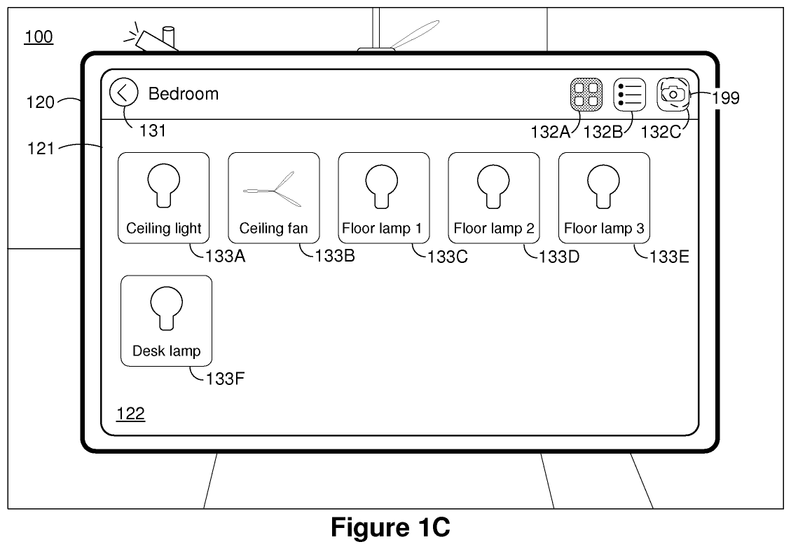

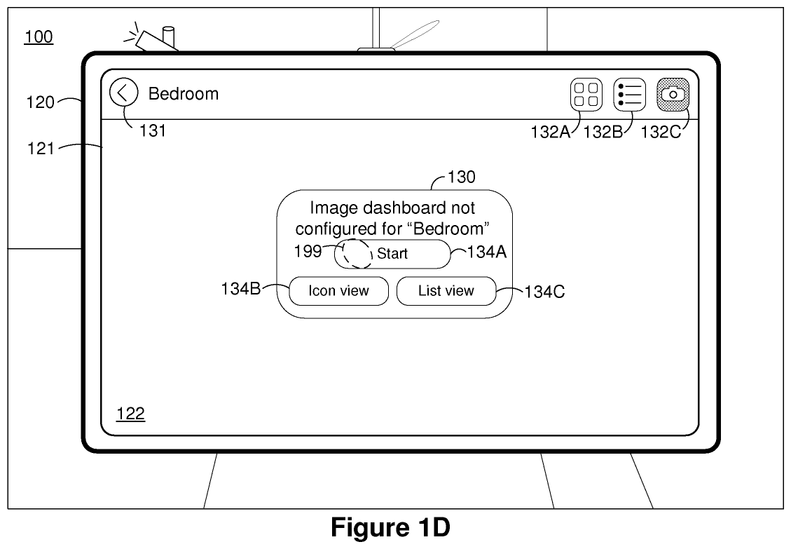

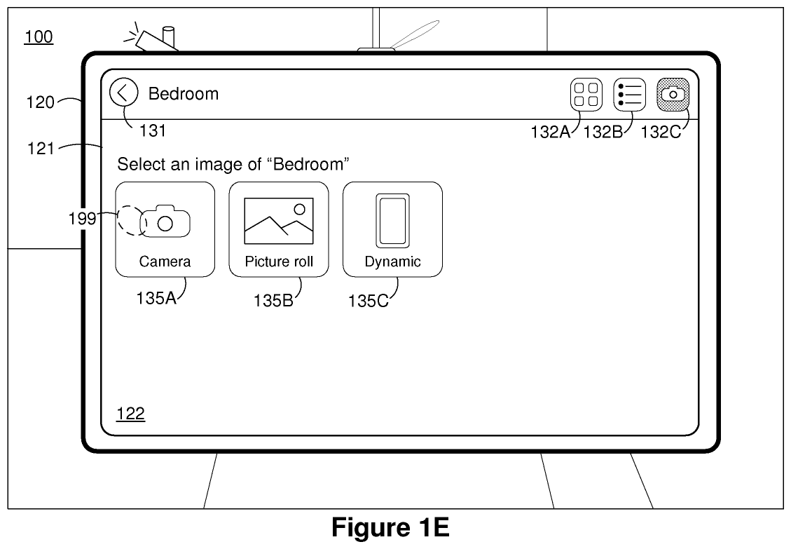

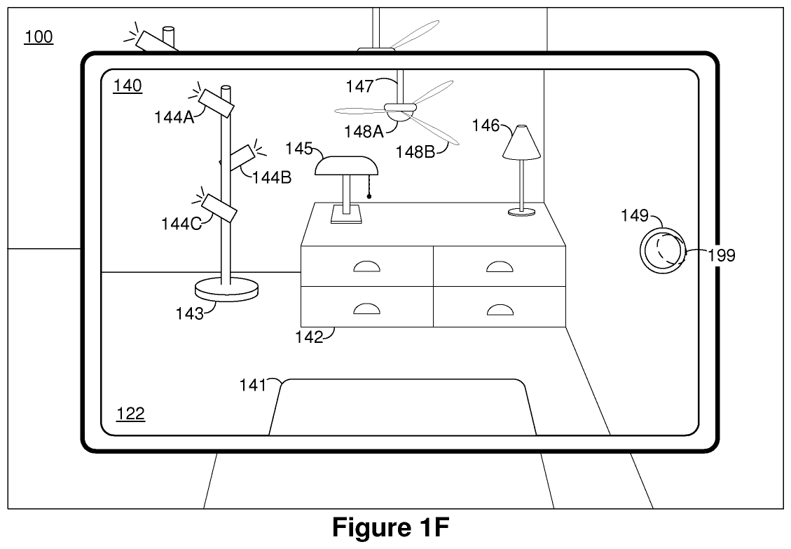

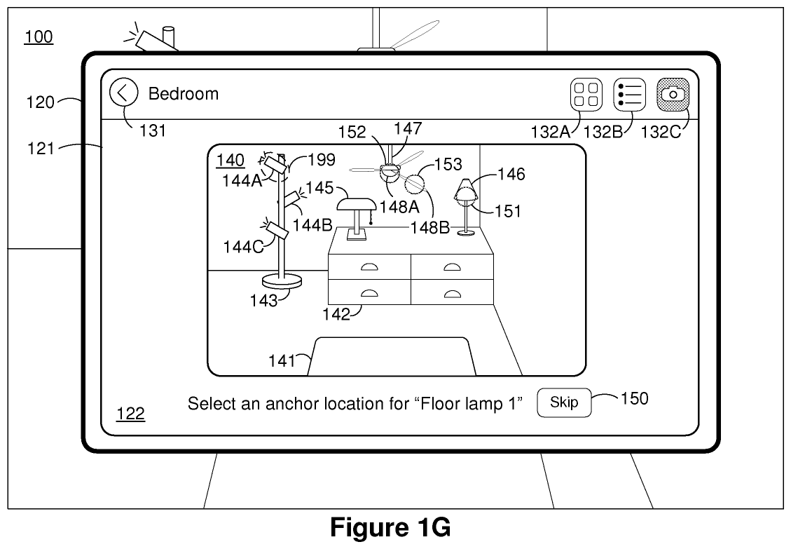

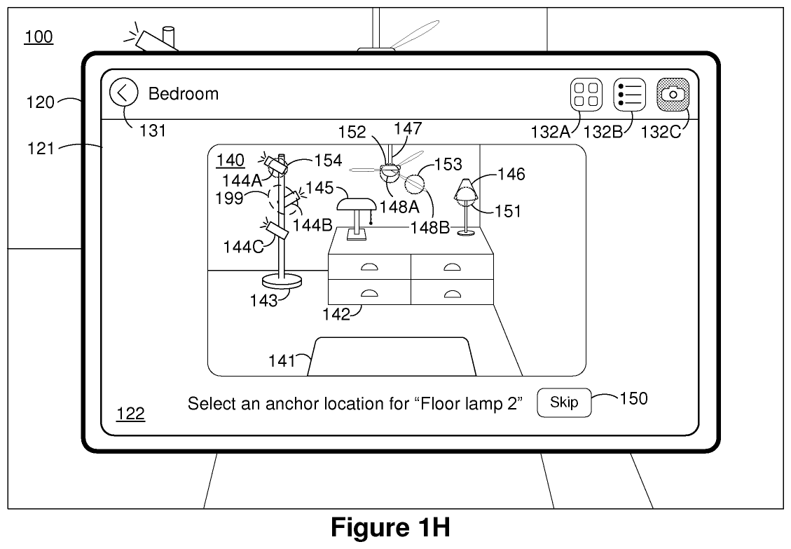

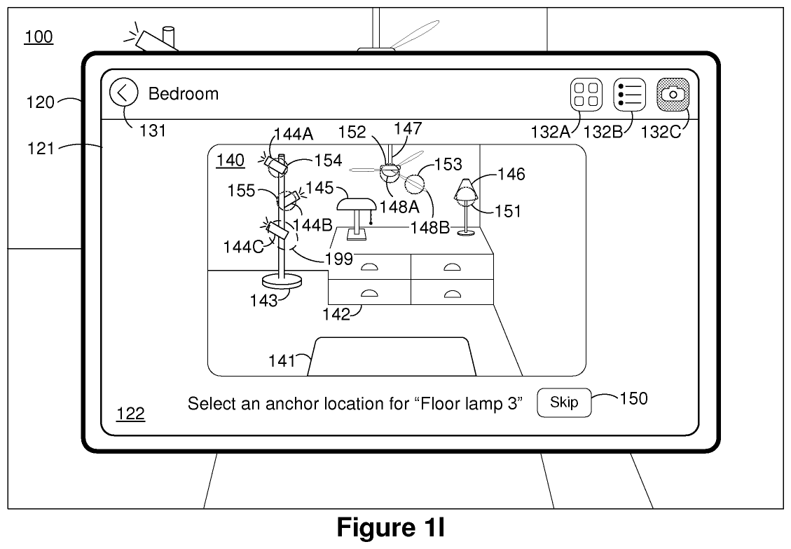

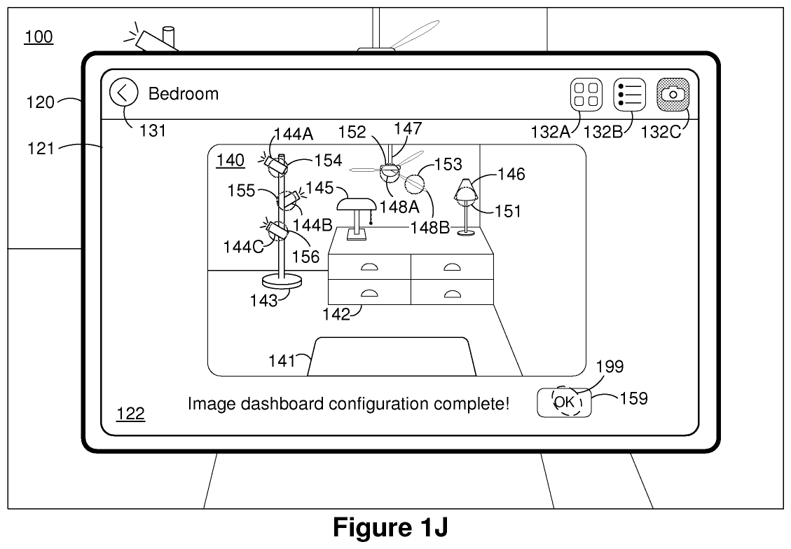

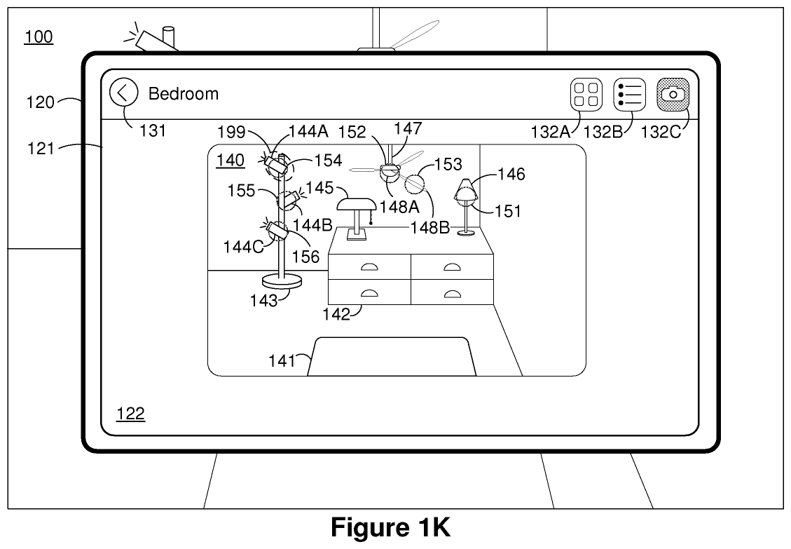

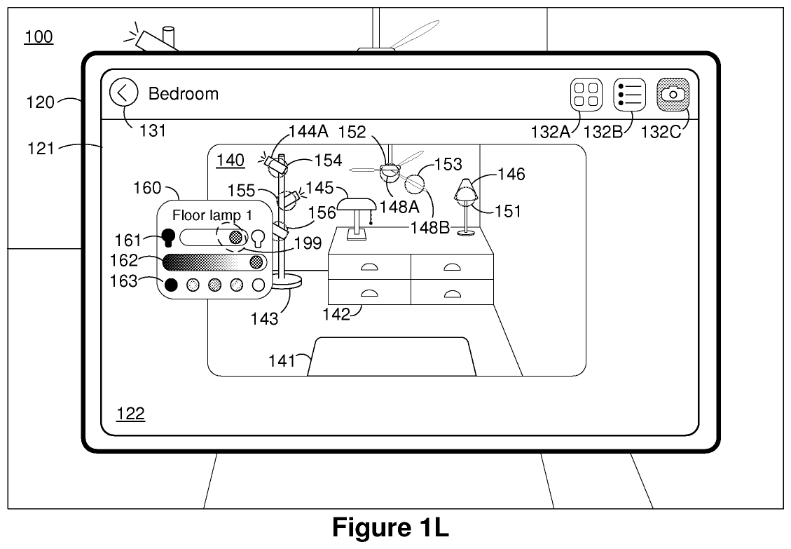

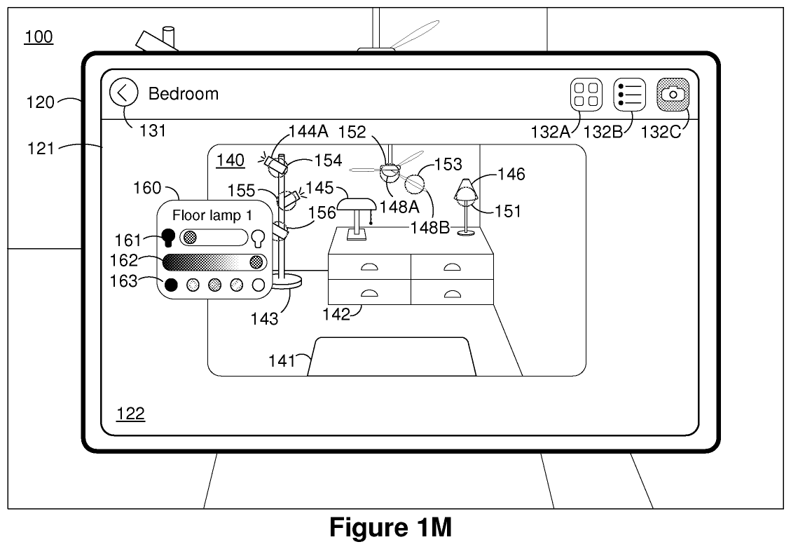

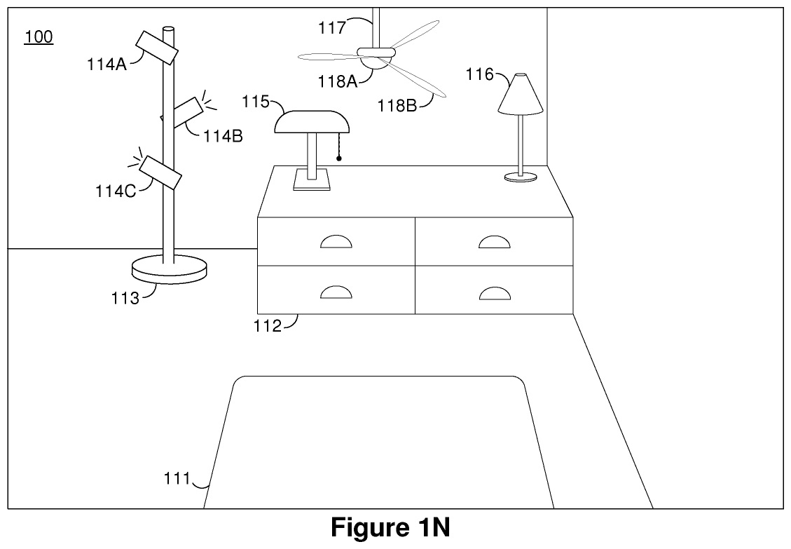

FIGS. 1A-1N illustrate a first physical environment 100 of a bedroom during a plurality of time periods in accordance with some implementations. In various implementations, each time period is an instant, a fraction of a second, a few seconds, a few hours, a few days, or any length of time.

The first physical environment 100 includes a bed 111, a desk 112, a floor lamp 113 including a first lightbulb 114A, a second lightbulb 114B, and a third lightbulb 114C, a banker's lamp 115, a desk lamp 116, and a ceiling fixture 117 including a ceiling light 118A and a ceiling fan 118B.

The first lightbulb 114A, the second lightbulb 114B, and the third lightbulb 114C have network connectivity and, in response to commands received over the network, change state. For example, in response to receiving a command from a home control application, the first lightbulb 114A turns on or off. As another example, in response to receiving a command from the home application, the second lightbulb 114B changes color.

A device with network connectivity that changes states in response to a command received over the network may be referred to as a “smart” device or a “controllable” device. In various implementations, a controllable device also transmits information regarding one or more states of the controllable device. For example, in various implementations, in response to query from the home control application, the third lightbulb 114C responds with a current value of a brightness of the third lightbulb 114C. In the first physical environment 100, the desk lamp 116, the ceiling light 118A, and the ceiling fan 118B are also controllable devices.

In order to transmit commands to different devices, in various implementations, the home control application stores a database of entries, each entry including a name of a device and a network address of the device. In various implementations, each entry includes additional information regarding the device, such as a device type of the device, a room identifier of a room in which the device is located, and/or an object model of the device (e.g., one or more images and/or a three-dimensional model of the device). In various implementations, a device associated with an entry in the database is referred to as an “enrolled” device.

FIG. 1B illustrates the first physical environment 100 during a second time period subsequent to the first time period. During the second time period, the first physical environment 100 includes an electronic device 120 with a display 121. In various implementations, the electronic device 120 is a watch, a phone, a tablet, a laptop, or a head-mounted device. The display 121 displays a home control user interface 122 of the home control application. During the second time period, the home control user interface 122 displays a launch screen.

The launch screen includes a routines region 125A including a plurality of routine affordances 126A-126C which, when activated, executes a respective routine. When executing a routine, the home control application transmits commands to multiple enrolled devices to change states to the multiple enrolled devices. For example, in response to activation of the wake up affordance 126A, the home control application transmits a first command to the desk lamp 116 to turn the desk lamp 116 on, a second command to a speaker to play a weather report, and a third command to a coffee maker to brew a cup of coffee. As another example, in response to activation of the got home affordance 126B, the home control application transmits a first command to a porch light to turn the porch light on, a second command to a lock to unlock a front door, and a third command to the speaker to play music. The routines region 125A further includes a good night affordance 126C which, when activated, executes a good night routine.

The launch screen includes a rooms region 125B including a plurality of room affordances 127A-127C which, when activated, cause the home control user interface 122 to display a respective room screen. For example, in response to activation of the bedroom affordance 127A, the home control user interface 122 displays a bedroom screen. As another example, in response to activation of the bathroom affordance 127B, the home control user interface 122 displays a bathroom screen. The rooms region 125B further includes a living room affordance 127C which, when activated, causes the home control user interface 122 to display a living room screen.

The launch screen includes a favorites region 125C including a plurality of favorite affordances 128A-128D which, when activated, cause the home control user interface 122 to display controls for respective enrolled devices. For example, in response to activation of the ceiling light favorite affordance 128A, the home control user interface 122 includes controls for turning the ceiling light 118A on or off, changing a brightness of the ceiling light 118A, and changing a color of the ceiling light 118A. As another example, in response to activation of the ceiling fan favorite affordance 128B, the home control user interface 122 includes controls for turning the ceiling fan 118B on or off and changing a fan speed of the ceiling fan 118B. In various implementations, a favorite affordance, when activated, transmits a command to an enrolled device without displaying controls (or requiring additional user input). For example, in response to activation of the heat lamp favorite affordance 128C, the home control application transmits a command to a heat lamp to change a state of the heat lamp (e.g., to turn the heat lamp on if the heat lamp is off or to turn the heat lamp off it the heat lamp is on). The favorites region 125C further includes a television favorite affordance 128D which, when activated, causes the home control user interface 122 to include controls for changing one or more states of a television.

FIG. 1B illustrates an input location indicator 199 indicating a location of a user input, such as tapping on the display 121. During the second time period, the user activates the bedroom affordance 127A (as indicated by the input location indicator 199).

FIG. 1C illustrates the first physical environment 100 during a third time period subsequent to the second time period. In response to detecting activation of the bedroom affordance 127A, the home control user interface 122 includes the bedroom screen. The bedroom screen includes a back affordance 131 which, when activated, replaces the bedroom screen with the launch screen. The bedroom screen includes a plurality of device affordances 133A-133F which, when activated, causes the home control user interface 122 to include controls for changing one or more states of enrolled devices that are associated with the “Bedroom” room. For example, the bedroom screen includes a ceiling light affordance 133A which, when activated, causes the home control user interface 122 to include controls for changing one or more states of the ceiling light 118A. As another example, the bedroom screen includes a ceiling fan affordance 133B which, when activated, causes the home control user interface 122 to include controls for changing one or more states of the ceiling fan 118B. As another example, the bedroom screen includes a first lightbulb affordance 133C which, when activated, causes the home control user interface 122 to include controls for changing one or more states of the first lightbulb 114A. As another example, the bedroom screen includes a second lightbulb affordance 133D which, when activated, causes the home control user interface 122 to include controls for changing one or more states of the second lightbulb 114B. As another example, the bedroom screen includes a third lightbulb affordance 133E which, when activated, causes the home control user interface 122 to include controls for changing one or more states of the third lightbulb 114C. As another example, the bedroom screen includes a desk lamp affordance 133F which, when activated, causes the home control user interface 122 to include controls for changing one or more states of the desk lamp 116. The bedroom screen includes an icon affordance 132A which, when selected, causes the plurality of device affordances 133A-133F to be displayed as icons arranged in a grid. During the third time period, the icon affordance 132A is selected and the plurality of device affordances 133A-133F are displayed as icons arranged in a grid. The bedroom screen includes a list affordance 132B which, when selected, causes the plurality of device affordances 133A-133F to be displayed as a list. When displayed as a list, the plurality of device affordances 133A-133F may have a different appearance (e.g., a different size, shape, and/or color) than when displayed as icons. The bedroom screen includes an image affordance 132C which, when selected, causes the plurality of device affordances 133A-133F to be displayed as part of an image. Similarly, when displayed as part of an image, the plurality of device affordances 133A-133F may have a different appearance than when displayed as icons. However, in each display mode, the plurality of device affordances 133A-133F have the same function when activated. During the third time period, the user selects the image affordance 132C (as illustrated by the input location indicator 199).

FIG. 1D illustrates the first physical environment 100 during a fourth time period subsequent to the third time period. In response to detecting selection of the image affordance 132C, the home control user interface 122 includes not-enrolled window 130 indicating that the home control application has not completed an image enrollment process for the “Bedroom” room in which portions of an image of the first physical environment 100 are configured to function as the plurality of device affordances 133A-133F. The not-enrolled window 130 includes a start affordance 134A which, when selected, initiates an image enrollment process of associating portions of an image of the first physical environment as the plurality of device affordances 133A-133F. The not-enrolled window 130 includes an icon view affordance 134B which, when selected causes the plurality of device affordances 133A-133F to be displayed as icons in a gird. The not-enrolled window 130 includes a list view affordance 134C which, when selected, causes the plurality of device affordances 133A-133F to be displayed as a list. During the fourth time period, the user activates the start affordance 134A (as illustrated by the input location indicator 199).

FIG. 1E illustrates the first physical environment 100 during a fifth time period subsequent to the fourth time period. In response to detecting selection of the start affordance 134A, the home control user interface 122 includes an image selection mode screen including a plurality of image selection mode affordances 135A-135C which, when activated, allows a user to select an image for the “Bedroom” room in different ways. For example, the image selection mode screen includes a camera affordance 135A which, when activated, allows a user to capture an image using a camera for use as the image for the “Bedroom” room. As another example, the image selection mode screen includes a picture roll affordance 135B which, when activated, allows a user to select a stored image for use as the image from the “Bedroom” room. As another example, the image selection mode screen includes a dynamic affordance 135C which, when activated, automatically generates the image for the “Bedroom” room as the user moves the electronic device 120 throughout the first physical environment 100. During the fifth time period, the user activates the camera affordance 135A (as illustrated by the input location indicator 199).

FIG. 1F illustrates the first physical environment 100 during a sixth time period subsequent to the fifth time period. In response to detecting activation of the camera affordance 135A, the home control user interface 122 includes an image of the first physical environment 140. The image of the first physical environment 140 includes a portion representing the bed 141, a portion representing the desk 142, a portion representing the floor lamp 143 including a portion representing the first lightbulb 144A, a portion representing the second lightbulb 144B, and a portion representing the third lightbulb 144C, a portion representing the banker's lamp 145, a portion representing the desk lamp 146, and a portion representing the ceiling fixture 147 including a portion representing the ceiling light 148A and a portion representing the ceiling fan 148B. The image of the first physical environment 140 changes in near real-time as the user changes perspective of a camera of the electronic device 120. Overlaid on the image of the first physical environment 140 is a capture affordance 149 which, when selected, saves the image of the first physical environment 140 as the image for the “Bedroom” room. During the sixth time period, the user activates the capture affordance 149 (as illustrated by the input location indicator 199).

FIG. 1G illustrates the first physical environment 100 during a seventh time period subsequent to the sixth time period. In response to detecting activation of the capture affordance 149, the home control user interface 122 includes the image of the first physical environment 140 as the image for the “Bedroom” room. Overlaid on the image of the first physical environment is a first anchor 151, a second anchor 152, and a third anchor 153. The first anchor 151 is displayed over the portion representing the desk lamp 146, the second anchor 152 is displayed over the portion representing the ceiling light 148A, and the third anchor 153 is displayed over the portion representing the ceiling fan 148B. The first anchor 151 corresponds to the desk lamp affordance 133F, the second anchor 152 corresponds to the ceiling light affordance 133A, and the third anchor 153 corresponds to the ceiling fan affordance 133B.

The home control application selects the location of the first anchor 151 based on comparing the portion representing the desk lamp 146 with an object model of the desk lamp 116 stored in the entry for the desk lamp 116. Similarly, the home control application selects the location of the second anchor 152 and the third anchor 153 based on object models of the ceiling light 118A and ceiling fan 118B.

During the seventh time period, the home control user interface 122 includes instructions to provide a location for a fourth anchor corresponding to the first lightbulb 114A and a skip affordance 150 which, when activated, does not assign an anchor to the enrolled device but allows the image enrollment process to continue. During the seventh time period, the user activates the portion representing the first lightbulb 144A.

FIG. 1H illustrates the first physical environment 100 during an eighth time period subsequent to the seventh time period. In response to detecting activation of the portion representing the first lightbulb 144A, the home control user interface 122 includes a fourth anchor 154 displayed over the portion representing the first lightbulb 144A corresponding to the first lightbulb affordance 133C. During the eighth time period, the home control user interface 122 includes instructions to provide a location for a fifth anchor corresponding to the second lightbulb 114B. During the eighth time period, the user activates the portion representing the second lightbulb 144B.

FIG. 1I illustrates the first physical environment 100 during a ninth time period subsequent to the eighth time period. In response to detecting activation of the portion representing the second lightbulb 144B, the home control user interface 122 includes a fifth anchor 155 displayed over the portion representing the second lightbulb 144B corresponding to the second lightbulb affordance 133D. During the ninth time period, the home control user interface 122 includes instructions to provide a location for a sixth anchor corresponding to the third lightbulb 114C. During the ninth time period, the user activates the portion representing the third lightbulb 144C.

FIG. 1J illustrates the first physical environment 100 during a tenth period subsequent to the ninth time period. In response to detecting activation of the portion representing the third lightbulb 144C, the home control user interface 122 includes a sixth anchor 156 displayed over the portion representing the third lightbulb 144C corresponding to the third lightbulb affordance 133E. Thus, overlaid on the image of the first physical environment 140 is an anchor for each enrolled device not skipped associated with the “Bedroom” room. Accordingly, the image enrollment process is complete. During the tenth time period, the home control user interface 122 includes an acknowledgement that the image enrollment process is complete and an OK affordance 159 which, when selected, displays the plurality of device affordances 133A-133F as the anchors 151-156 overlaid on the image of the first physical environment 140. During the tenth time period, the user activates the OK affordance 159.

FIG. 1K illustrates the first physical environment 100 during an eleventh period subsequent to the tenth time period. In response to detecting activation of the OK affordance, the home control user interface 122 includes the image of the first physical environment 140 overlaid with anchors 151-156. During the eleventh time period, the user activates the fourth anchor 154 corresponding to the first lightbulb affordance 133C (as illustrated by the input location indicator 199).

FIG. 1L illustrates the first physical environment 100 during a twelfth time period subsequent to the eleventh time period. In response to detecting activation of the fourth anchor 154, the home control user interface 122 includes controls for changing one or more states of the first lightbulb 114A. In particular, the home control user interface 122 includes a first lightbulb window 160 including an on/off affordance 161 which, when activated, causes the home control application to transmit a command to the first lightbulb 114A to turn on or off, a brightness affordance 162 which, when activated, causes the home control application to transmit a command to the first lightbulb 114A to change to a designated brightness, and a color affordance 163 which, when activated, cause the home control application to transmit a command to the first lightbulb 114A to change to a designated color. In various implementations, the on/off affordance 161 indicates whether the first lightbulb 114A is on or off. During the twelfth time period, the on/off affordance 161 indicates that the first lightbulb 114A is on. In various implementations, the brightness affordance 162 indicates a current brightness of the first lightbulb 114A and the color affordance 163 indicates a current color of the first lightbulb 114A. During the twelfth time period, the user activates the on/off affordance 161 (as illustrated by the input location indicator 199).

FIG. 1M illustrates the first physical environment 100 at a thirteenth time period subsequent to the twelfth time period. In response to detecting activation of the on/off affordance 161, the home control application transmits a command to the first lightbulb 114A to turn the first lightbulb 114A off. The home control application receives a confirmation that the first lightbulb 114A is off and updates the on/off affordance 161 in the home control user interface 122 to indicate the first lightbulb 114A is off. In various implementations, the confirmation is transmitted by the first lightbulb 114A in response to the command. In various implementations, the confirmation is transmitted by the first lightbulb 114A in response to a query transmitted by the home control application at a time period after the command was transmitted.

FIG. 1N illustrates the first physical environment 100 at a fourteenth time period subsequent to the thirteenth time period. During the fourteenth time period, the electronic device 120 has been removed from the first physical environment 100 and it is evident that the first lightbulb 114A has been turned off.

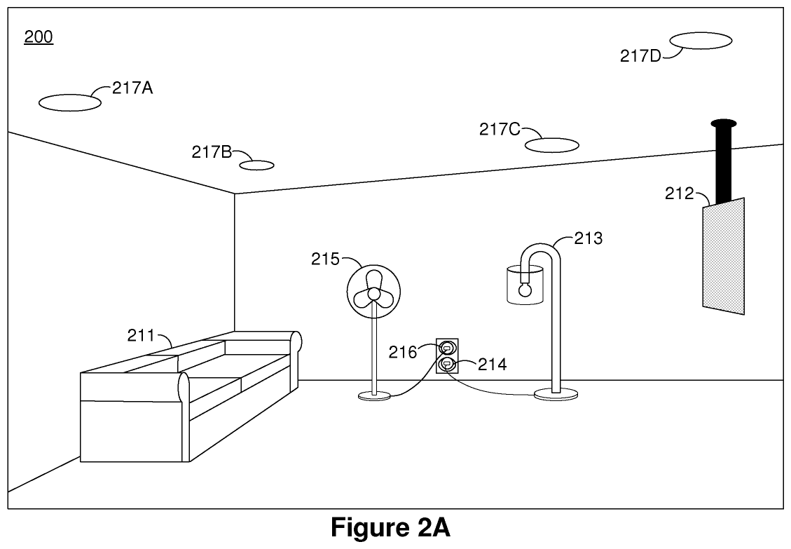

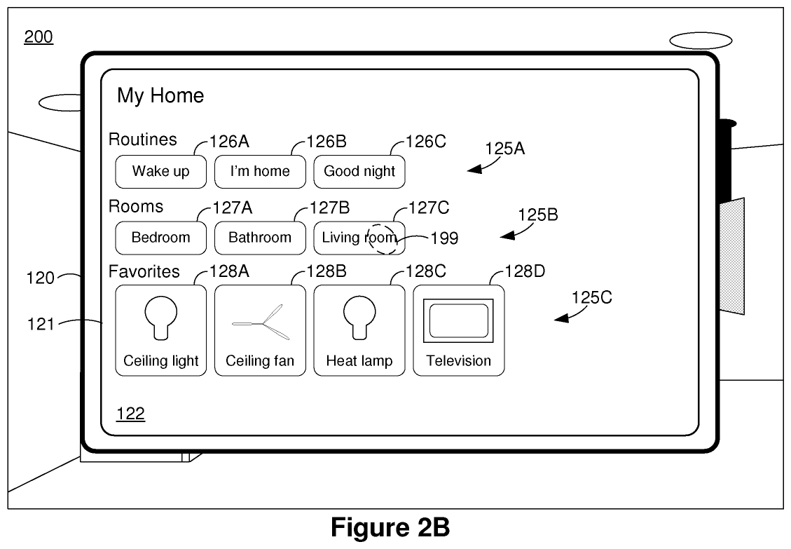

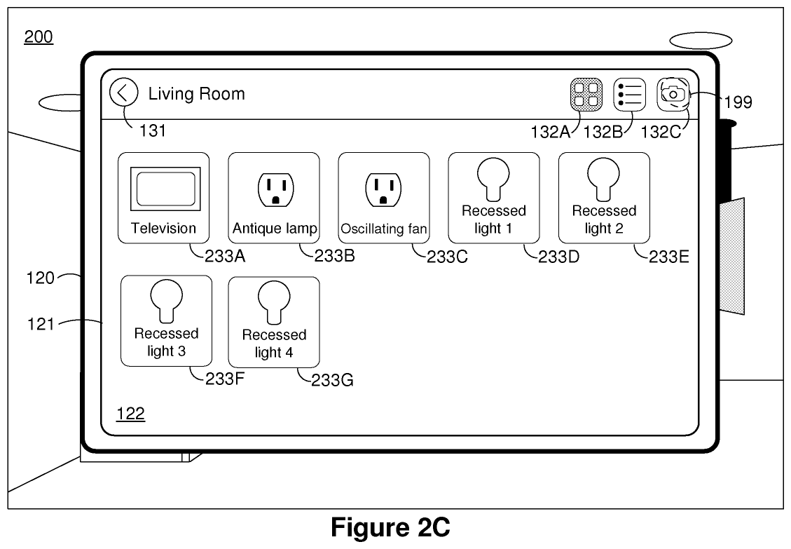

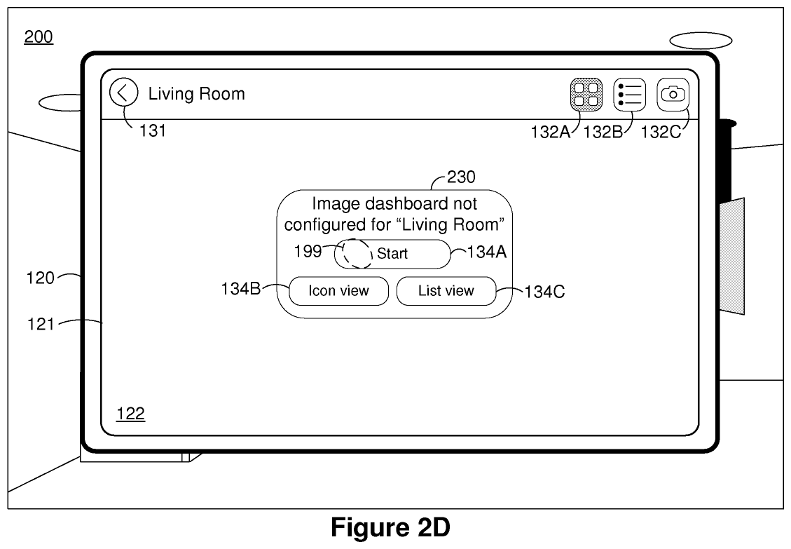

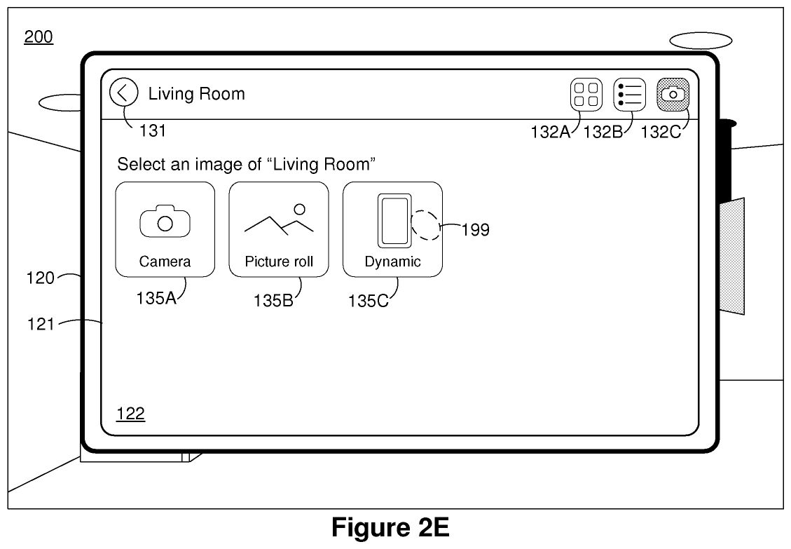

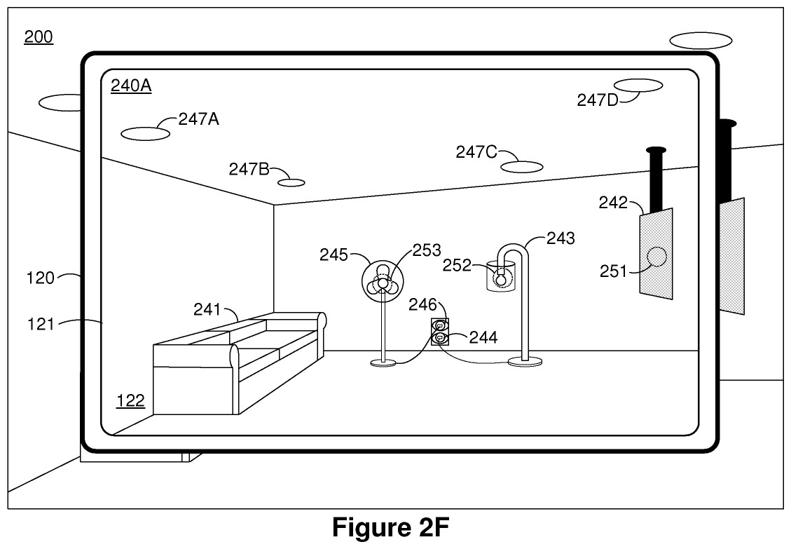

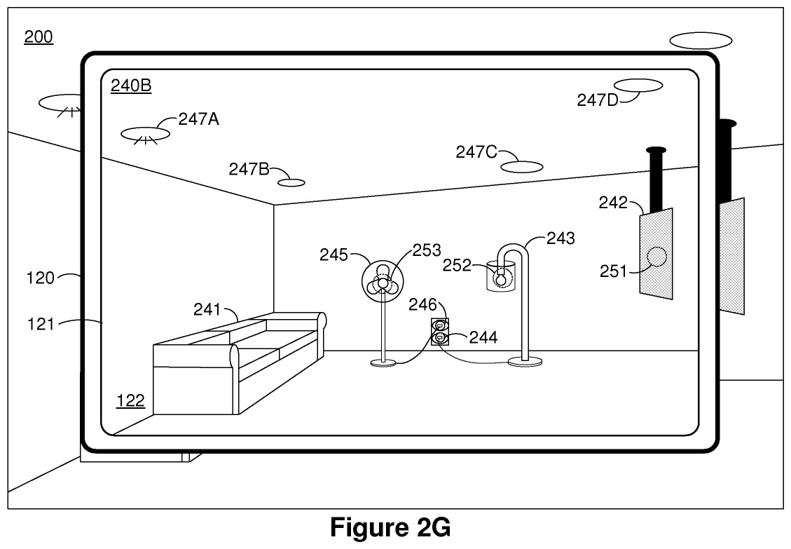

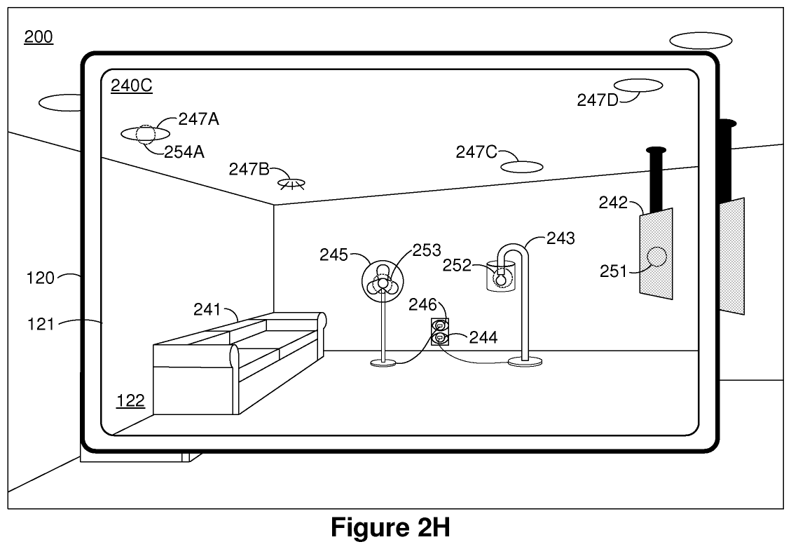

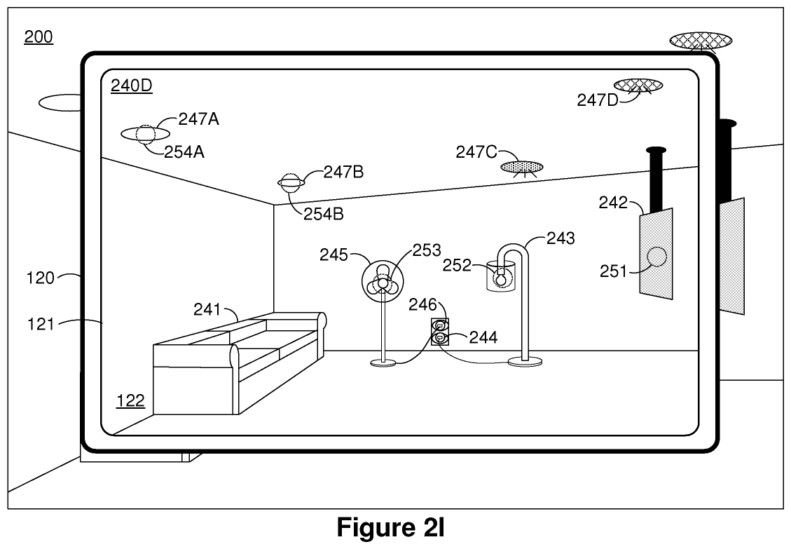

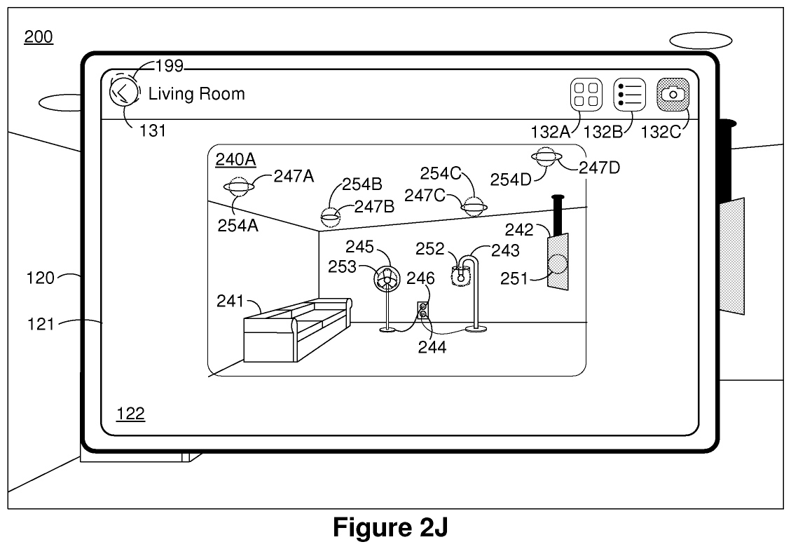

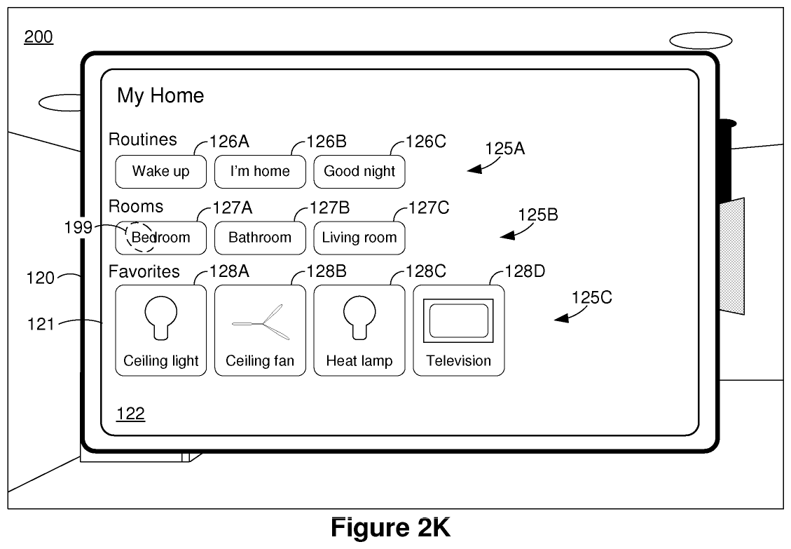

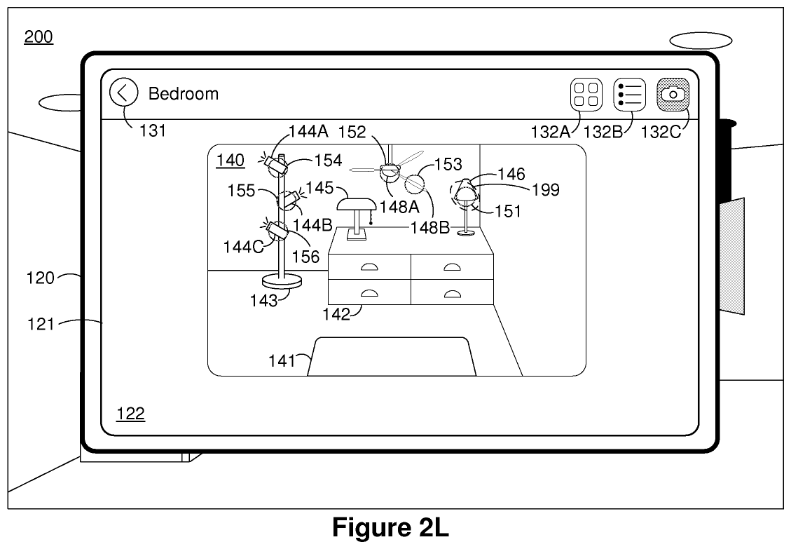

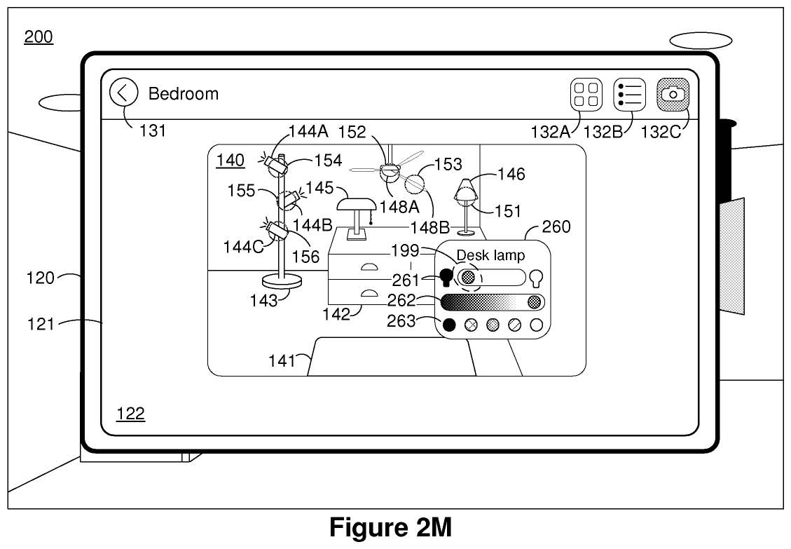

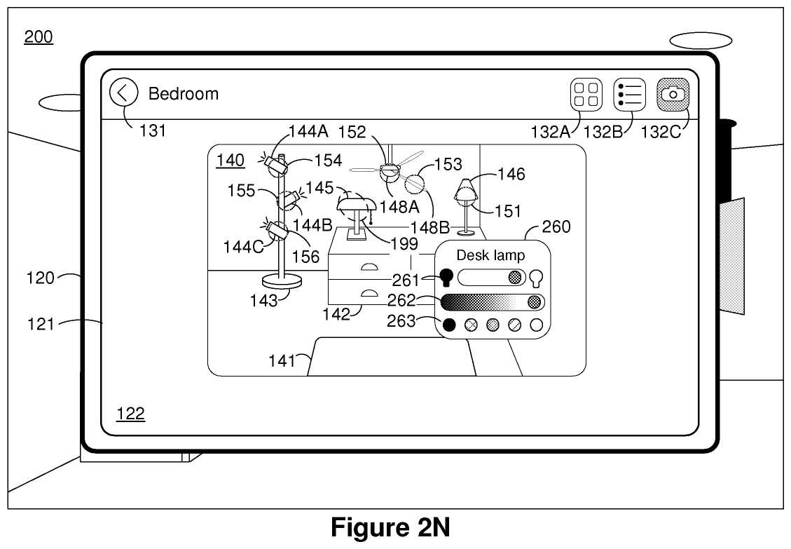

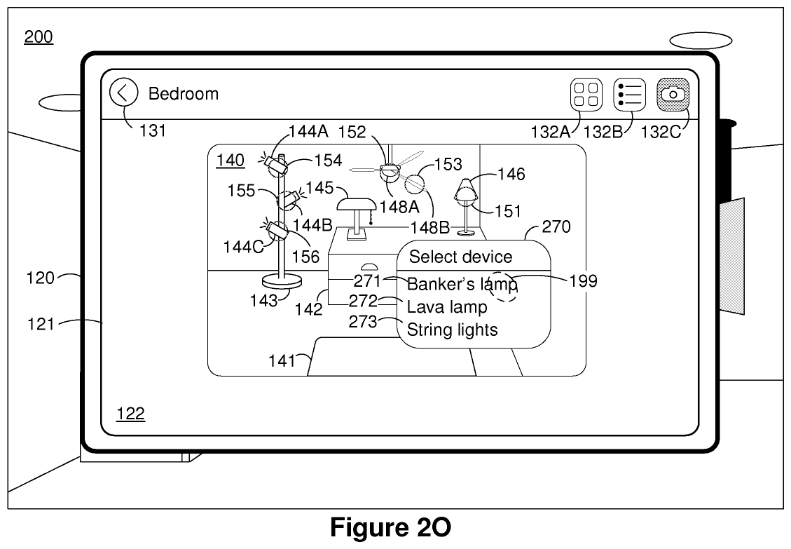

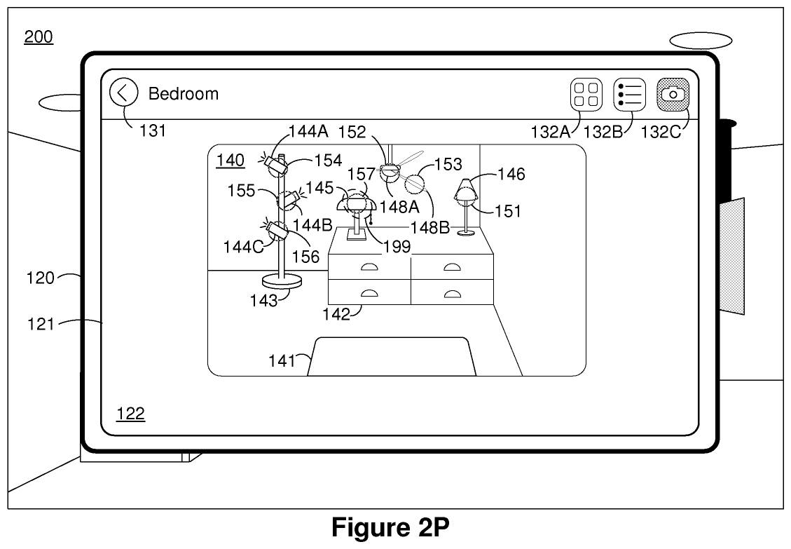

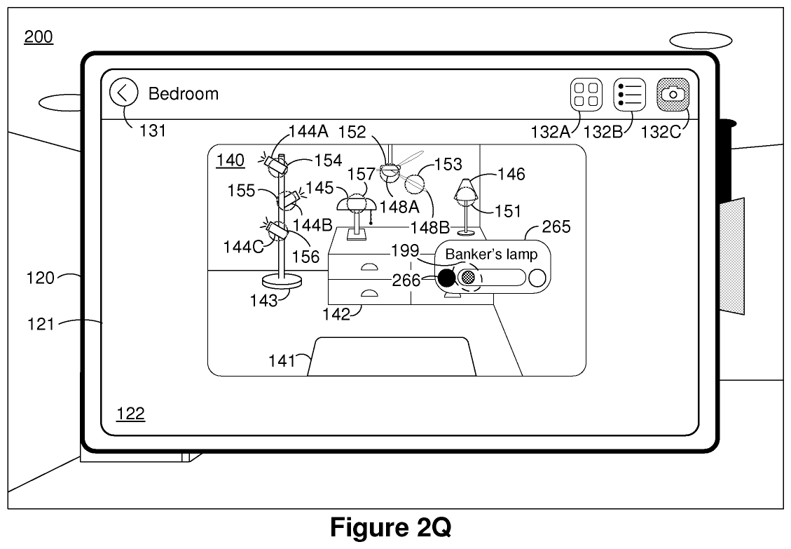

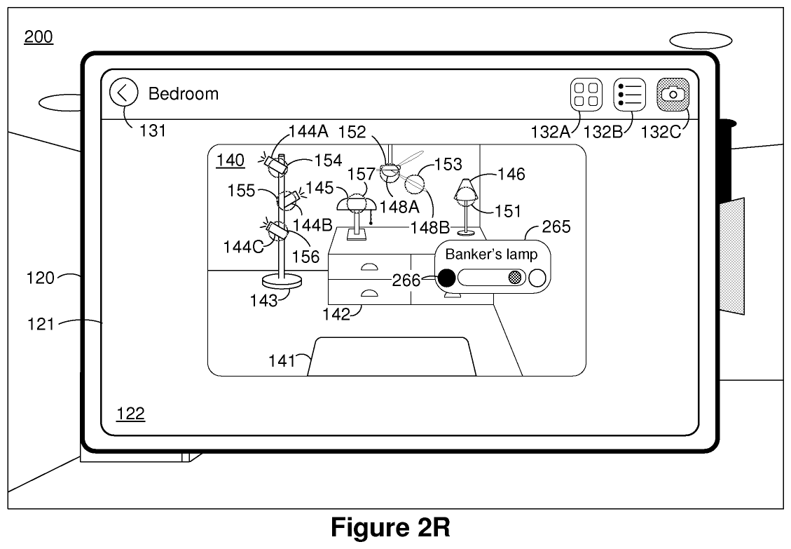

FIGS. 2A-2R illustrate a second physical environment 200 of a living room during a plurality of time periods in accordance with some implementations. FIG. 2A illustrates the second physical environment 200 during a first time period. For ease of reference, the counting of time periods is reset in describing FIGS. 2A-2R, while the first time period of FIG. 2A is subsequent to the fourteenth time period of FIG. 1N. The second physical environment 200 includes a couch 211, a television 212, an antique lamp 213 plugged into a first plug 214, an oscillating fan 215 plugged into a second plug 216, a first recessed light 217A, a second recessed light 217B, a third recessed light 217C, and a fourth recessed light 217D. The television 212, the first plug 214, the second plug 216, and the recessed lights 217A-217D are enrolled devices with the home control application.

FIG. 2B illustrates the second physical environment 200 during a second time period subsequent to the first time period. During the second time period, the second physical environment 200 includes the electronic device 120 with the home control user interface 122 on the display 121. During the second time period, the home control user interface 122 displays the launch screen. During the second time period, the user activates the living room affordance 127C (as illustrated by the input location indicator 199).

FIG. 2C illustrates the second physical environment 200 during a third time period subsequent to the second time period. In response to detecting activation of the living room affordance 127C, the home control user interface 122 includes the living room screen. The living room screen includes a plurality of device affordances 233A-233G which, when selected, causes the home control user interface 122 to include controls for changing one or more states of the corresponding device. In particular, the living room screen includes a television affordance 233A which, when activated, cause the home control user interface 122 to includes controls for changing one or more states of the television 212. The living room screen includes a first plug affordance 233B which, when activated, cause the home control user interface 122 to include controls for changing one or more states of the first plug 214. In various implementations, the first plug 214 only has a single changeable state (e.g., an on/off state). Thus, in various implementations, when activated, rather than displaying controls for changing the state, the home control application transmits a command to the first plug 214 to change the state. The living room screen includes a second plug affordance 233C which, when activated, causes the home control user interface 122 to include controls for changing one or more states of the second plug 216 (or simply transmits a command to change the state of the second plug 216). The living room screen includes a first recessed light affordance 233D which, when activated, causes the home control user interface 122 to include controls for changing one or more states of the first recessed light 217A. The living room screen includes a second recessed light affordance 233E which, when activated, causes the home control user interface 122 to include controls for changing one or more states of the second recessed light 217B. The living room screen includes a third recessed light affordance 233F which, when activated, causes the home control user interface 122 to include controls for changing one or more states of the third recessed light 217C. The living room screen includes a fourth recessed light affordance 233G which, when activated, causes the home control user interface 122 to include controls for changing one or more states of the fourth recessed light 217D.

The living room screen includes the back affordance 131, the icon affordance 132A, the list affordance 132B, and the image affordance 132C. During the second time period, the user activates the image affordance 132C (as illustrated by the input location indicator 199).

FIG. 2D illustrates the second physical environment 200 during a fourth time period subsequent to the third time period. In response to detecting activation of the image affordance 132C, the home control user interface 122 includes not-enrolled window 230 indicating that the home control application has not completed an image enrollment process for the “Living Room” room in which portions of an image of the second physical environment 200 are configured to function as the plurality of device affordances 233A-233G. The not-enrolled window 230 includes the start affordance 134A, the icon view affordance 134B, and the list view affordance 134C. During the fourth time period, the user activates the start affordance 134A (as illustrated by the input location indicator 199).

FIG. 2E illustrates the second physical environment 200 during a fifth time period subsequent to the fourth time period. In response to detecting selection of the start affordance 134A, the home control user interface 122 includes the image selection mode screen including the plurality of image selection mode affordances 135A-135C which, when activated, allows a user to select an image for the “Living” room in different ways. During the fifth time period, the user activates the dynamic affordance 135C (as illustrated by the input location indicator 199).

FIG. 2F illustrates the second physical environment 200 during a sixth time period subsequent to the fifth time period. In response to detecting activation of the dynamic affordance 135C, the home control user interface 122 includes a first image of the second physical environment 240A. The first image of the second physical environment 240A includes a portion representing the couch 241, a portion representing the television 242, a portion representing the antique lamp 243, a portion representing the first plug 244, a portion representing the oscillating fan 245, a portion representing the second plug 246, a portion representing the first recessed light 247A, a portion representing the second recessed light 247B, a portion representing the third recessed light 247C, and a portion representing the fourth recessed light 247D.

Unlike the image of the first physical environment 140 of FIG. 1F, the first image of the second physical environment 240A does not have a capture affordance overlaid thereon. Rather, the home control application periodically stores captured images of the second physical environment and either selects one of the captured images as the image for the “Living Room” room, stitches multiple captured images together to form the image for the “Living Room” room, or performs a 3D reconstruction to create a 3D model of the “Living Room” using the multiple captured images. However, overlaid on the first image of the second physical environment 240A is a first anchor 251, a second anchor 252, and a third anchor 253. The first anchor 251 is displayed over the portion representing the television 242, the second anchor 252 is displayed over the portion representing the antique lamp 243, and the third anchor 253 is displayed over the portion resenting the oscillating fan 245. The first anchor 251 corresponds to the television affordance 233A, the second anchor 252 corresponds to the first plug affordance 233B, and the third anchor 253 corresponds to the second plug affordance 233C.

In various implementations, the home control application determines the location of the first anchor 251, second anchor 252, and third anchor 253 based on object models of the television 212, the antique lamp 213, and the oscillating fan 215. However, because each of the recessed lights 217A-217D have a similar appearance, the home control application cannot distinguish them based on their object models. To address a similar problem with the first lightbulb 114A, the second lightbulb 114B, and the third lightbulb 114C, the home control user interface 122 includes instructions to a user to provide locations. However, in the dynamic mode, the home control application distinguishes between similar devices by transmitting commands to change a state of the devices.

FIG. 2G illustrates the second physical environment 200 during a seventh time period subsequent to the sixth time period. Between the sixth time period and the seventh time period, the home control application transmitted a command to the first recessed light 217A to turn on. Accordingly, during the seventh time period, the first recessed light 217A is on (as indicated by the corresponding portion representing the first recessed light 247A in a second image of the second physical environment 240B).

FIG. 2H illustrates the second physical environment 200 during an eighth time period subsequent to the seventh time period. Between the seventh time period and the eighth time period, the home control application transmitted a first command to the first recessed light 217A to turn off and a second command to the second recessed light 217B to turn on. Accordingly, during the eighth time period, the first recessed light 217A is off and the second recessed light 217B is on (as indicated by the corresponding portion representing the first recessed light 247A and portion representing the second recessed light 247B in a third image of the second physical environment 240C). In response to detecting the portion representing the first recessed light 247A change between the first image of the second physical environment 240A and the second image of the second physical environment 240B, the home control application adds a fourth anchor 254A to the portion representing to the first recessed light 247A corresponding to the first recessed light affordance 233D.

FIG. 2I illustrates the second physical environment 200 during a ninth time period subsequent to the eighth time period. Between the eighth time period and the ninth time period, the home control application transmitted a first command to turn the second recessed light 217B to turn off, a second command to turn the third recessed light 217C on and red, and a third command to turn the fourth recessed light 217D on and green. Accordingly, during the ninth time period, the second recessed light 217B is off, the third recessed light 217C is on and red, and the fourth recessed light 217D is on and green (as indicated by the corresponding portion representing the second recessed light 247B, portion representing the third recessed light 247C, and portion representing the fourth recessed light 247D in a fourth image of the second physical environment 240D). In response to detecting the portion representing the second recessed light 247B change between the second image of the second physical environment 240B and the third image of the second physical environment 240C, the home control application adds a fifth anchor 254B to the portion representing the second recessed light 247B corresponding to the second recessed light affordance 233E.

FIG. 2J illustrates the second physical environment 200 during a tenth time period subsequent to the ninth time period. Between the ninth time period and the tenth time period, the home control application transmitted a first command to turn the third recessed light 217C off and a second command to turn the fourth recessed light 217D off. In response to detecting the portion representing the third recessed light 247C change to red between the third image of the second physical environment 240C and the fourth image of the second physical environment 240D, the home control application adds a sixth anchor 254C to the portion representing the third recessed light 247C corresponding to the third recessed light affordance 233F. Similarly, in response to detecting the portion representing the fourth recessed light 247D change to green between the third image of the second physical environment 240C and the fourth image of the second physical environment 240D, the home control application adds a seventh anchor 254D to the portion representing the fourth recessed light 247D corresponding to the fourth recessed light affordance 233G.

In various implementations, the home control application determines the portion of an image of a physical environment by detecting a change in brightness or color. In various implementations, the home control application determines the portion of an image of a physical environment by detecting movement. For example, in various implementations, the home control application determines the location of the portion representing the oscillating fan 245 by detecting motion of the oscillating fan 215 when the second plug 216 is turned on. In various implementations, the home control application determines the portion of an image of a physical environment by detecting sound. For example, in various implementations, the home control application determines the location of the portion representing the oscillating fan 245 by detecting sound made by the oscillating fan 215 when the second plug 216 is turned on.

During the tenth time period, the anchors 251-254D function as the plurality of device affordances 233A-233G such that activation of the anchor (or the corresponding portion of the first image of the second physical environment 240A) causes the home control user interface 122 to include controls for changing one or more states of the corresponding device.

During the tenth time period, the user activates the back affordance 131 (as indicated by the input location indicator 199).

FIG. 2K illustrates the second physical environment 200 during an eleventh time period subsequent to the tenth time period. In response to detecting activation of the back affordance 131, the home control user interface 122 includes the launch screen. During the eleventh time period, the user activates the bedroom affordance 127A (as indicated by the input location indicator 199).

FIG. 2L illustrates the second physical environment 200 during a twelfth time period subsequent to the eleventh time period. In response to detecting activation of the bedroom affordance 127A, the home control user interface 122 includes the bedroom screen including the image of the first physical environment 140 overlaid with the anchors 151-156. During the twelfth time period, the user activates the first anchor 151 (as indicated by the input location indicator 199).

FIG. 2M illustrates the second physical environment 200 during a thirteenth time period subsequent to the twelfth time period. In response to detecting activation of the first anchor 151, the home control user interface 122 includes controls for changing one or more states of the desk lamp 116. In particular, the home control user interface 122 includes a desk lamp window 260 including an on/off affordance 261 which, when activated, causes the home control application to transmit a command to the desk lamp 116 to turn on or off, a brightness affordance 262 which, when activated, causes the home control application to transmit a command to the desk lamp 116 to change to a designated brightness, and a color affordance 263 which, when activated, cause the home control application to transmit a command to the desk lamp 116 to change to a designated color. In various implementations, the on/off affordance 261 indicates whether the desk lamp 116 is on or off. During the thirteenth time period, the on/off affordance 261 indicates that the desk lamp 116 is off. In various implementations, the brightness affordance 262 indicates a current brightness of the desk lamp 116 and the color affordance 263 indicates a current color of the desk lamp 116. During the thirteenth time period, the user activates the on/off affordance 261 (as illustrated by the input location indicator 199).

FIG. 2N illustrates the second physical environment 200 at a fourteenth time period subsequent to the thirteenth time period. In response to detecting activation of the on/off affordance 261, the home control application transmits a command to the desk lamp 116 to turn the desk lamp 116 on. The home control application receives a confirmation that the desk lamp 116 is on and updates the on/off affordance 261 in the home control user interface 122 to indicate the desk lamp 116 is on.

Accordingly, a user can change the state of an enrolled object in the first physical environment 100 while the electronic device 120 is in the second physical environment 200. In particular, a user can change the state of an enrolled object without knowing the name of the enrolled object while in a different physical environment. As an example, while inside, a user can change the state of a set of outdoor lights to alternate between red and green without having to remember the order or arrangement in the outdoor physical environment of “Outdoor light 1”, “Outdoor light 2”, “Outdoor light 3”, “Outdoor light 4”, and “Outdoor light 5”.

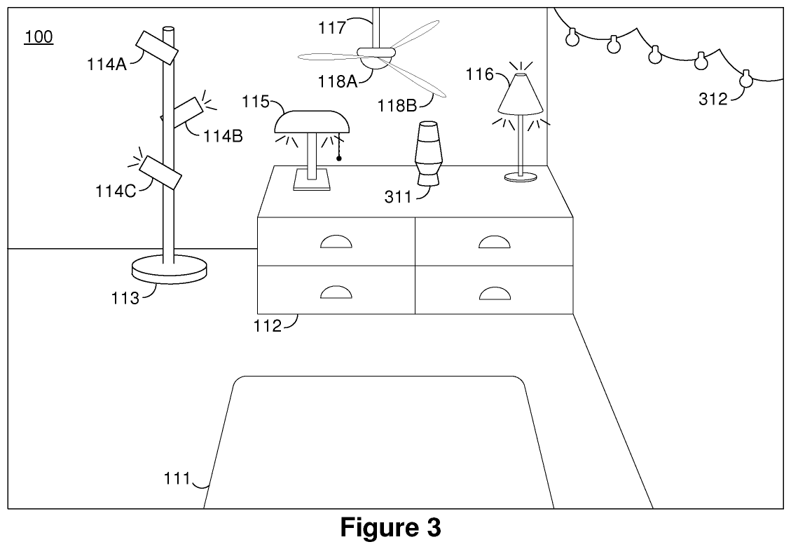

Before the fourteenth time period of FIG. 2N (but after the coincidentally similarly numbered fourteenth time period of FIG. 1N), the user added a third plug, a fourth plug, and a fifth plug to the first physical environment 100. The user also added a lava lamp 311 and string lights 312 to the first physical environment 100 (as illustrated in FIG. 3 described below). Thus, the user plugged the banker's lamp 115 into the third plug, the lava lamp 311 into the fourth plug, and the string lights 312 into the fifth plug. Further, the user enrolled the third plug with the home control user interface with the name “Banker's lamp” and associated the third plug with the “Bedroom” room. Similarly, the user enrolled the fourth plug with the name “Lava lamp” and the fifth plug with the name “String lights” and associated both the fourth plug and the fifth plug with the “Bedroom” room. During the fourteenth time period of FIG. 2N, the user activates the portion representing the banker's lamp 145 of the image of the first physical environment 140 (as indicated by the input location indicator 199).

FIG. 2O illustrates the second physical environment 200 during a fifteenth time period subsequent to the fourteenth time period. In response to detecting activation of the portion representing the banker's lamp 145, the home control user interface 122 includes a device selection window 270. The device selection window 270 includes a list of enrolled devices associated with the “Bedroom” room without anchors in the image of the first physical environment. For example, the device selection window 270 includes a banker's lamp selection affordance 271 which, when activated, associates an anchor at the portion representing the banker's lamp 145 with the third plug. Similarly, the device selection window 270 includes a lava lamp selection affordance 272 and a string light selection affordance 273 which, when selected, associated an anchor at the portion representing the banker's lamp 145 with the fourth plug or fifth plug, respectively. During the fifteenth time period, the user activates the banker's lamp selection affordance 271 (as indicated by the input location indicator 199).

FIG. 2P illustrates the second physical environment 200 during a sixteenth time period subsequent to the fifteenth time period. In response to detecting activation of the banker's lamp selection affordance 271, the image of the first physical environment 140 includes a seventh anchor 157 which corresponds to a device affordance for changing one or more states of the third plug. During the sixteenth time period, the user activates the seventh anchor 157 (as indicated by the input location indicator 199).

FIG. 2Q illustrates the second physical environment 200 during a seventeenth time period subsequent to the sixteenth time period. In response to detecting activation of the seventh anchor 157, the home control user interface 122 includes controls for changing one or more states of the third plug. In particular, the home control user interface 122 includes a third plug window 265 including an on/off affordance 266 which, when activated, causes the home control application to transmit a command to the third plug to turn on or off. In various implementations, the on/off affordance 266 indicates whether the third plug is on or off. During the seventeenth time period, the on/off affordance 266 indicates that the third plug is off. During the seventeenth time period, the user activates the on/off affordance 266 (as illustrated by the input location indicator 199).

FIG. 2R illustrates the second physical environment 200 at an eighteenth time period subsequent to the seventeenth time period. In response to detecting activation of the on/off affordance 266, the home control application transmits a command to the third plug to turn the third plug on. The home control application receives a confirmation that the third plug is on and updates the on/off affordance 266 in the home control user interface 122 to indicate the third plug is on.

FIG. 3 illustrates the first physical environment 100 during a first time period. For ease of reference, the counting of time periods is reset in describing FIG. 3, while the first time period of FIG. 3 is subsequent to the eighteenth time period of FIG. 2R. In response to detecting the activation of the on/off affordance 261 during the thirteenth time period of FIG. 2M, the desk lamp 116 is on. Further, in response to detecting the activation of the on/off affordance 266 during the seventeenth time period of FIG. 2Q, the third plug (and, thus, the banker's lamp 115 plugged into the third plug) is on.

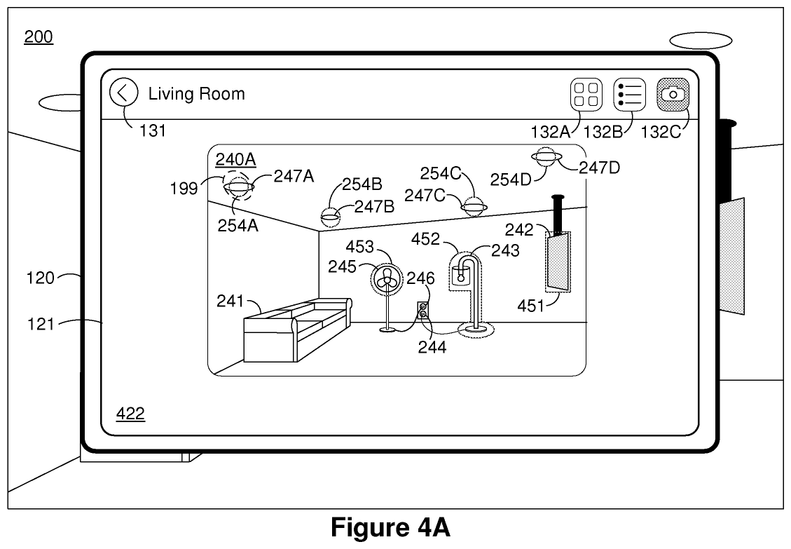

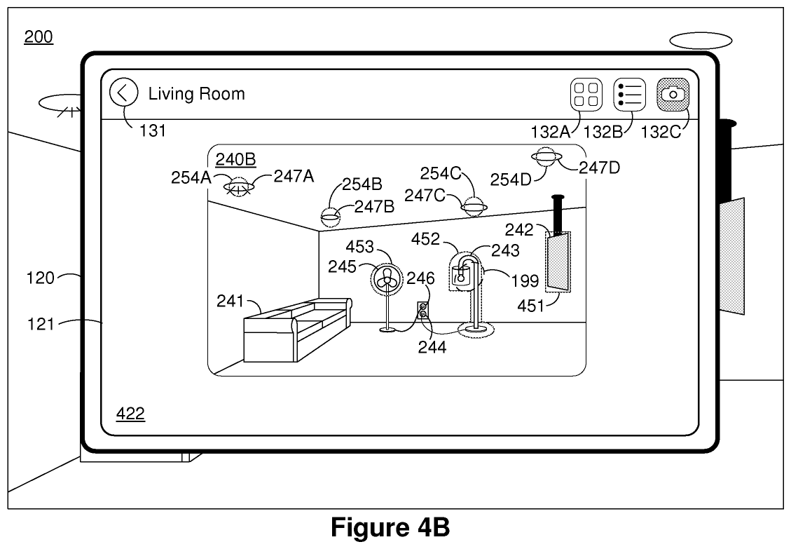

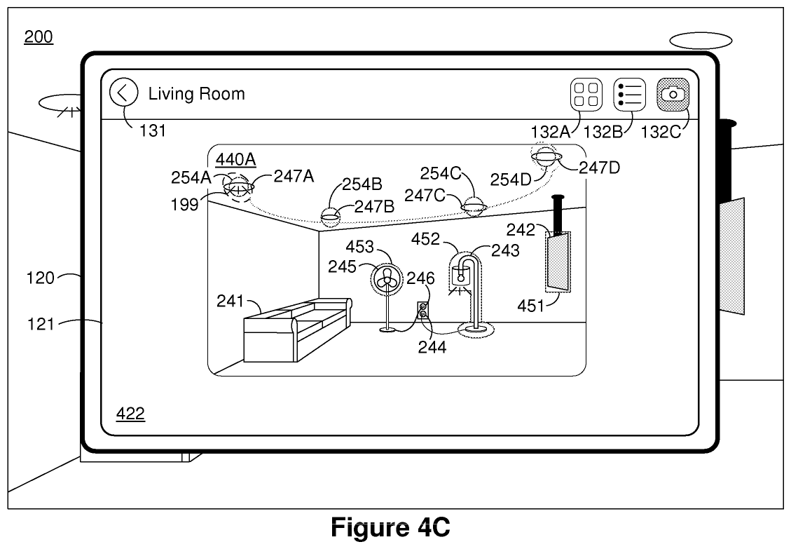

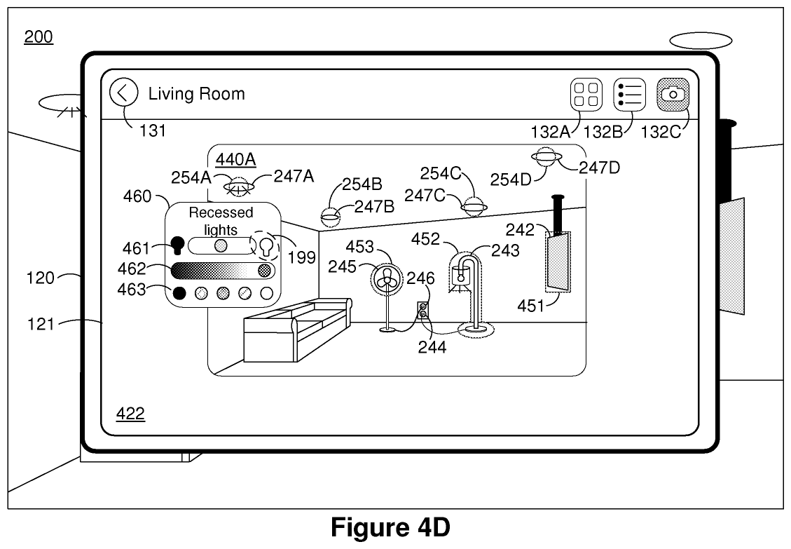

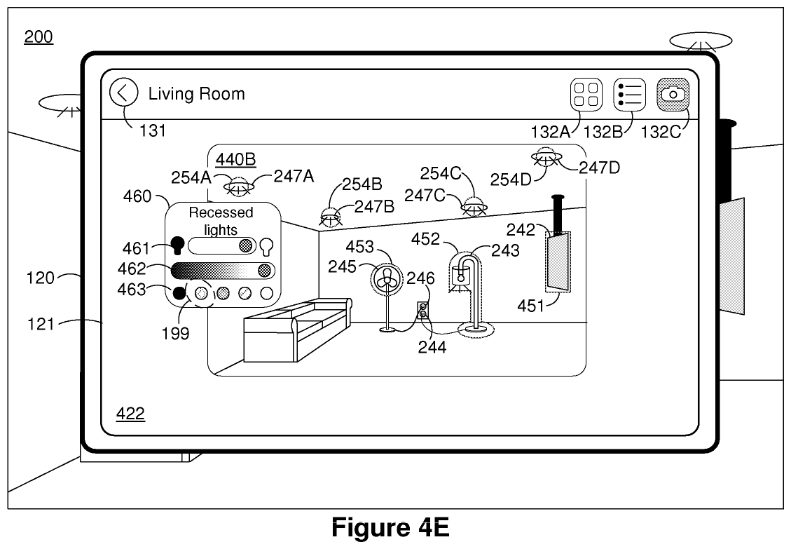

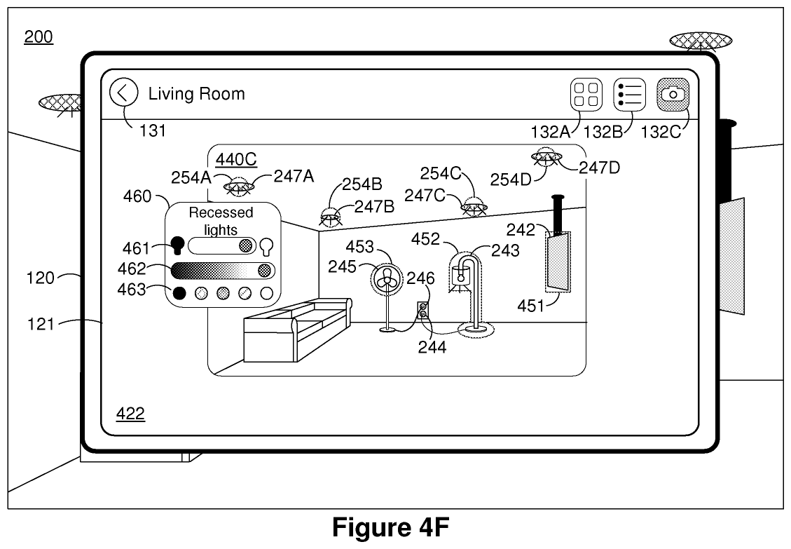

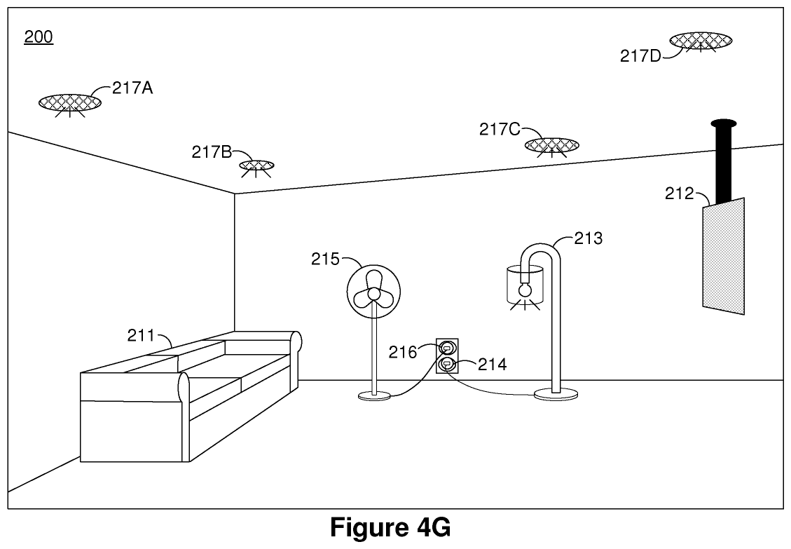

FIGS. 4A-4G illustrate the second physical environment 200 including the electronic device 120 displaying an alternative home control user interface 422 of the home control application during a plurality of time periods in accordance with some implementations. FIG. 4A illustrates the second physical environment 200 during a first time period. For ease of reference, the counting of time periods is reset in describing FIG. 4A-4G, while the first time period of FIG. 4A is subsequent to the first time period of FIG. 3.

During the first time period, the alternative home control user interface 422 includes the first image of the second physical environment 240A with the fourth anchor 254A, the fifth anchor 254B, the sixth anchor 254C, and the seventh anchor 254D overlaid thereon. Further, overlaid on the first image of the second physical environment 240A is an alternative first anchor 451, an alternative second anchor 452, and an alternative third anchor 453. The alternative first anchor 451 is displayed over the portion representing the television 242, the alternative second anchor 452 is displayed over the portion representing the antique lamp 243, and the alternative third anchor 453 is displayed over the portion resenting the oscillating fan 245. The alternative first anchor 451 corresponds to the television affordance 233A, the alternative second anchor 452 corresponds to the first plug affordance 233B, and the alternative third anchor 453 corresponds to the second plug affordance 233C. The alternative first anchor 451 is a bounding box surrounding the portion representing the television 242. The alternative second anchor 452 is shaped like the object model of the antique lamp 213. The alternative third anchor 453 is a circle that is larger than the third anchor 253 of FIG. 2F. Thus, it is to be appreciated that the anchors can be any size and/or shape. During the first time period, the user activates the fourth anchor 254A (as indicated by the input location indicator 199).

FIG. 4B illustrates the second physical environment 200 at a second time period subsequent to the first time period. In response to detecting activation of the fourth anchor 254A, the home control application transmits a command to the first recessed light 217A to turn the first recessed light 217A on. Thus, in various implementations, activation of an anchor causes the home control application to transmit a command rather than to display controls on the home control user interface. The home control application receives a confirmation that the first recessed light 217A is on and changes the alternative home control user interface 422 to display (rather than the first image of the second physical environment 240A) the second image of the second physical environment 240B captured during the eighth time period of FIG. 2H during which the first recessed light 217A was on. During the second time period, the user activates the alternative second anchor 452 (as indicated by the input location indicator 199).

FIG. 4C illustrates the second physical environment 200 during a third time period subsequent to the second time period. In response to detecting activation of the alternative second anchor 452, the home control application transmits a command to the first plug 214 to turn the first plug 214 on. The home control application receives a confirmation that the first plug 214 is on and changes the alternative home control user interface 422 to display (rather than the second image of the second physical environment 240A) a first virtual image of the second physical environment 440A in which the antique lamp 213 is on (as shown in the portion representing the antique lamp 243). In various implementations, the home control application generates the first virtual image using generative artificial intelligence to modify an image of the second physical environment, such as the second image of the second physical environment 240B, such that the antique lamp 213 is on. During the third time period, the user concurrently activates the fourth anchor 254A, the fifth anchor 254B, the sixth anchor 254C, and the seventh anchor 254D. In various implementations, the user concurrently activates multiple anchors by dragging a contact across the display 121.

FIG. 4D illustrates the second physical environment 200 during a fourth time period subsequent to the third time period. In response to detecting concurrent activation of the fourth anchor 254A, the fifth anchor 254B, the sixth anchor 254C, and the seventh anchor 254D, the alternative home control user interface 422 includes controls for concurrently changing one or more states of the first recessed light 217A, the second recessed light 217B, the third recessed light 217C, and the fourth recessed light 217D. In particular, the alternative home control user interface 422 includes a recessed lights window 460 including an on/off affordance 461 which, when activated, causes the home control application to transmit a command to each of the recessed lights 217A-217D to turn on or off, a brightness affordance 462 which, when activated, causes the home control application to transmit a command to each of the recessed lights 217A-217D to change to a designated brightness, and a color affordance 463 which, when activated, cause the home control application to transmit a command to each of the recessed lights 217A-217D to change to a designated color. During the fourth time period, the user activates the on/off affordance 461 (as illustrated by the input location indicator 199).

FIG. 4E illustrates the second physical environment 200 at a fifth time period subsequent to the fourth time period. In response to detecting activation of the on/off affordance 461, the home control application transmits a command to each of the recessed lights 217A-217D to turn each of the recessed lights 217A-217D on. The home control application receives a confirmation that each of the recessed lights 217A-217D is on and updates the on/off affordance 461 in the alternative home control user interface 422 to indicate the recessed lights 217A-217D are on. Further, the home control application changes the alternative home control user interface 422 to display (rather than the first virtual image of the second physical environment 440A) a second virtual image of the second physical environment 440B in which the recessed lights 217A-217D are on. During the fifth time period, the user activates the color affordance 463 (as illustrated by the input location indicator 199).

FIG. 4F illustrates the second physical environment 200 at a sixth time period subsequent to the fifth time period. In response to detecting activation of the color affordance 463, the home control application transmits a command to each of the recessed lights 217A-217D to turn each of the recessed lights 217A-217D green. The home control application receives a confirmation that each of the recessed lights 217A-217D is green and updates the color affordance 463 in the alternative home control user interface 422 to indicate the recessed lights 217A-217D are green. Further, the home control application changes the alternative home control user interface 422 to display (rather than the second virtual image of the second physical environment 440A) a third virtual image of the second physical environment 440C in which the recessed lights 217A-217D are green.

FIG. 4G illustrates the second physical environment 200 at a seventh time period subsequent to the sixth time period. During the seventh time period, the electronic device 120 has been removed from the second physical environment 200 and it is evident that the first plug 214 (and antique lamp 213) are on and that the recessed lights 217A-217D are on and green.

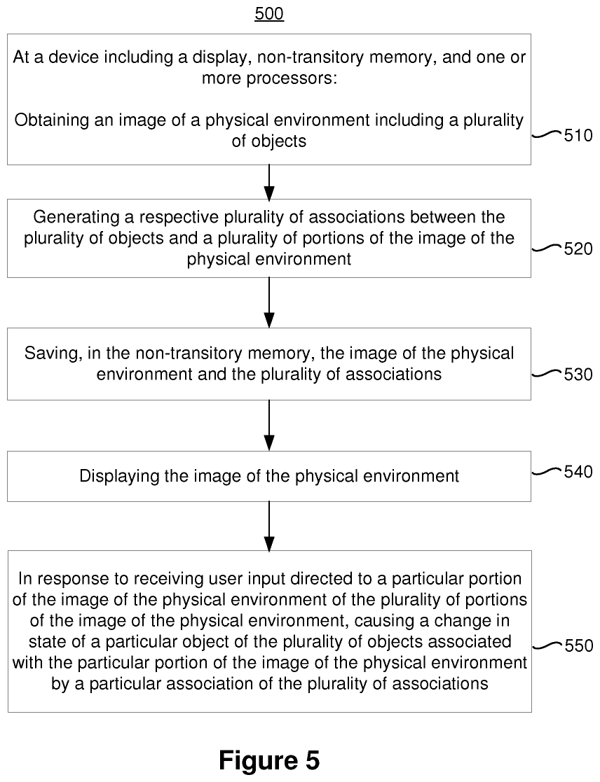

FIG. 5 is a flowchart representation of a method 500 of changing a state of an object in accordance with some implementations. In various implementations, the method 500 is performed by an electronic device, such as the electronic device 120 of FIG. 1A-4G. In various implementations, the method 500 is performed by a device including a display non-transitory memory, and one or more processors. In some implementations, the method 500 is performed by processing logic, including hardware, firmware, software, or a combination thereof. In some implementations, the method 500 is performed by a processor executing instructions (e.g., code) stored in a non-transitory computer-readable medium (e.g., a memory).

The method 500 begins, in block 510, with the device obtaining an image of a physical environment including a plurality of objects. In various implementations, obtaining the image of the physical environment includes receiving a user input capturing the image of the physical environment. For example, in FIG. 1F, the electronic device 120 captures the image of the first physical environment 140 in response to the user activating the capture affordance 149. In various implementations, obtaining the image of the physical environment includes receiving a user input selecting the image of the physical environment from a plurality of images. For example, in FIG. 1E, in response to the user activating the picture roll affordance 135B, the user can select the image of the physical environment from a plurality of images stored on the electronic device 120 or in a cloud storage. In various implementations, obtaining the image of the physical environment includes automatically capturing a plurality of images of the physical environment and generating the image of the physical environment based on the plurality of images of the physical environment. For example, in FIGS. 2F-2I, the electronic device 120 automatically captures a plurality of images of the second physical environment 240A-240D and selects the first image of the second physical environment 240A. Accordingly, in various implementations, generating the image of the physical environment includes selecting the image of the physical environment from the plurality of images of the physical environment. In various implementations, generating the image of the physical environment includes combining two or more of the plurality of images of the physical environment. For example, in various implementations, the device stitches together multiple images to form a panorama or wide field-of-view image including the plurality of objects.

In various implementations, the plurality of objects includes a plurality of smart objects or controllable objects which have network connectivity and can change state in response to commands transmitted over the network. In various implementations, the plurality of objects includes a plurality of enrolled objects having entries in a database of a home control application. In various implementations, each entry includes a name of an enrolled object and a network address of the enrolled object. In various implementations, each entry includes additional information regarding the enrolled object such as a room identifier of a room associated with the enrolled object or an object model of the enrolled object.

The method 500 continues, in block 520, with the device generating a respective plurality of associations between the plurality of objects and a plurality of portions of the image of the physical environment. Each portion of the image of the physical environment can be defined by a set of pixels of the image of the physical environment. In various implementations, the set of pixels is contiguous. However, in various implementations, the portion of the image of the physical environment can include disjoint sub-portions.

In various implementations, generating a particular association (between a particular portion of the image of the physical environment and a particular object) is based on a user input directed to a location of the image of the physical environment. For example, in FIG. 1G, in response to a user input directed to the portion representing the first lightbulb 144A in the image of the first physical environment 140, the electronic device 120 generates an association between the portion representing the first lightbulb 144A and the first lightbulb 114A. In various implementations, generating the particular association is based on an object model of the particular object. For example, in FIG. 1G, the electronic device 120 generates an association between the portion representing the desk lamp 146 and the desk lamp 116 based on an object model of the desk lamp 116.

In various implementations, generating the particular association includes transmitting one or more commands to the particular object to change a state of the particular object. For example, in FIG. 2G, the electronic device 120 has transmitted a command to the first recessed light 217A to turn on. In response to detecting the first recessed light 217A turn on in the portion representing the first recessed light 247A of the second image of the second physical environment 240B, the electronic device 120 generates an association between the portion representing the first recessed light 247A and the first recessed light 217A. As another example, in FIG. 2I, the electronic device has transmitted a command to the third recessed light 217C to turn on and green. In response to detecting the third recessed light 217C turn on and green in the portion representing the third recessed light 247C of the fourth image of the second physical environment 240D, the electronic device 120 generates an association between the portion representing the third recessed light 247C and the third recessed light 217C.

In various implementations, the particular portion of the image of the physical environment is at a location of the particular object in the image of the physical environment. For example, in FIG. 2J, the first anchor 251 is at a location of the television 212 in the image of the physical environment (e.g., the portion representing the television 242). In various implementations, the particular portion of the image of the physical environment is at a location a distance from the particular object in the image of the physical environment. For example, in FIG. 2J, the second anchor 252 is at a location of the antique lamp 213 in the first image of the second physical environment 240A (e.g., the portion representing the antique lamp 243) which is a distance from a location of the first plug 214 in the first image of the second physical environment 240A (e.g., the portion representing the first plug 244). As another example, the portion of the image of the physical environment may be located at a light switch rather than a lightbulb or lamp which receives commands to change state.

It is to be appreciated that the portions of the image of the physical environment can be any shape or size and different portions may be different shapes and/or sizes or the same shape and/or size. In particular, in various implementations, the particular portion of the image of the physical environment is circular. For example, in FIG. 4A, the alternative third anchor 453 is circular. In various implementations, the particular portion of the of the image of the physical environment is rectangular. For example, in FIG. 4A, the alternative first anchor 451 is rectangular. In various implementations, the particular portion of the image of the physical environment is shaped based on an object model of the particular object. For example, in FIG. 4A, the alternative second anchor 452 is based on an object model of the first plug 214 (which is shaped like the antique lamp 213).

The method 500 continues, in block 530, with the device saving, in the non-transitory memory, the image of the physical environment and the plurality of associations. In various implementations, the device stores the plurality of associations (between objects and portions) in respective entries of the database of the objects. In various implementations, the device saves the image of the physical environment and the plurality of associations in a long-term storage and can access the image of the physical environment and the plurality of associations at a later time, such as when the device has turned off and turned back on or when the device has left the physical environment.

The method 500 continues, in block 540, with the device displaying the image of the physical environment. In various implementations, displaying the image of the physical environment is performed while the device is within the physical environment. For example, in FIG. 2J, the electronic device 120 displays the first image of the second physical environment 240A while the electronic device 120 is within the second physical environment 200. In various implementations, displaying the image of the physical environment is performed while the device is outside the physical environment. For example, in FIG. 2L, the electronic device 120 displays the image of the first physical environment 140 while the device is outside the first physical environment 100 (and is in the second physical environment 200).

In various implementations, the method 500 includes, before displaying the image of the physical environment, moving the device from within the physical environment to outside the physical environment. For example, in FIG. 2J, the electronic device 120 displays the image of the first physical environment 140 after the electronic device has moved from the first physical environment 100 to the second physical environment 200. In various implementations, the method 500 includes, before displaying the image of the physical environment, ceasing display of the image of the physical environment. For example, in FIG. 1M, the electronic device 120 displays the image of the first physical environment 140. Later, in FIG. 2J, the electronic device 120 ceases display of the image of the first physical environment 140 and displays, instead, the first image of the second physical environment 240A. Later again, in FIG. 2L, the electronic device 120 re-displays the image of the first physical environment 140.

In various implementations, displaying the image of the physical environment includes displaying a respective plurality of anchors over the plurality of portions of the image of the physical environment. For example, in FIG. 2L, the electronic device 120 displays the anchors 151-156 over the image of the first physical environment 140. In various implementations, a particular anchor surrounds or is coextensive with the particular portion of the image of the physical environment. Thus, in various implementations, a particular anchor is the same size and/or shape as the particular portion of the image of the physical environment. In various implementations, a particular anchor has a different size and/or shape than the particular portion of the image of the physical environment. For example, in FIG. 4A, the alternative second anchor 452 corresponds to the first plug affordance 233B. However, in various implementations, the first plug affordance 233B may be the shape of the alternative second anchor 452 while the circular second anchor 252 (as in FIG. 2J) is displayed.

In various implementations, the method 500 includes, while displaying the image of the physical environment, receiving a user input generating a new association between a new object and a new portion of the image of the physical environment. For example, in FIGS. 2N-2O, the user provides user input for generating an association between the third plug and the portion representing the banker's lamp 145 in the image of the first physical environment 140.

The method 500 continues, in block 550, with the device, in response to receiving user input directed to a particular portion of the image of the physical environment of the plurality of portions of the image of the physical environment, causing a change in state of a particular object of the plurality of objects associated with the particular portion of the image of the physical environment by a particular association of the plurality of associations. In various implementations, causing the change in state of the particular object includes displaying one or more controls for changing one or more states of the particular object. For example, in FIG. 1L, in response to detecting the user activate the fourth anchor 154, the electronic device 120 displays the first lightbulb window 160 including controls for changing one or more states of the first lightbulb 114A. In various implementations, causing the change in state of the particular object includes transmitting a command to the particular object. For example, in FIG. 1M, in response to detecting the user activate the on/off affordance 161, the electronic device 120 transmits a command to the first lightbulb 114A to turn the first lightbulb 114A off. As another example, in FIG. 4B, in response to detecting the user activate the fourth anchor 254A, the electronic device 120 transmits a command to the first recessed light 217A to turn the first recessed light 217A on.

In various implementations, causing the change in state of the particular object includes causing a change in state of multiple objects of the plurality of objects. For example, in FIG. 4E, in response to detecting the user activate the color affordance 463, the electronic device 120 transmits a command to each of the recessed lights 217A-217D to turn each of the recessed lights 217A-217D green.

In various implementations, the method 500 further includes, after causing the change in state of the particular object, displaying an updated image of the physical environment based on the change in state of the particular object. For example, in FIG. 4B, in response to causing the first recessed light 217A to turn on, the electronic device 120 displays the second image of the second physical environment 240B rather than the first image of the second physical environment 240A. As another example, in FIG. 4C, in response to causing the first plug to turn on (turning on the antique lamp 213), the electronic device 120 displays the first virtual image of the second physical environment 440A rather than the second image of the second physical environment 240B.

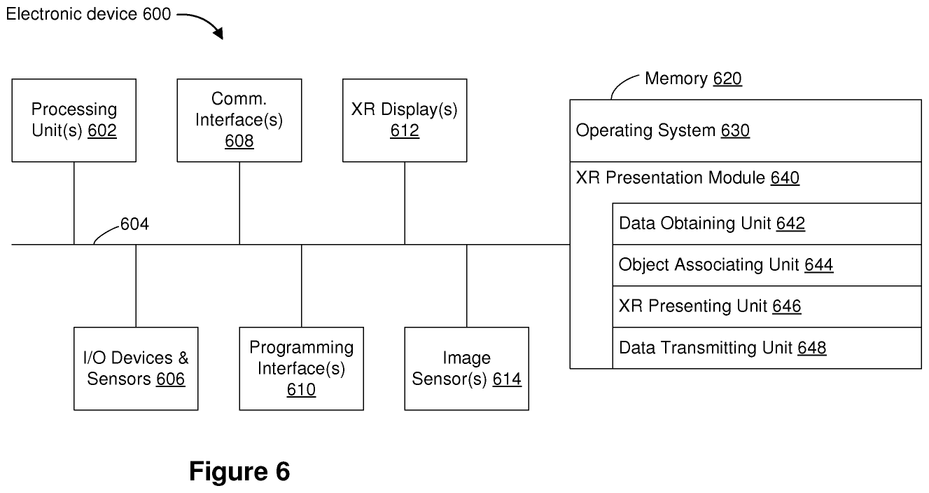

FIG. 6 is a block diagram of an electronic device 600 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 600 includes one or more processing units 602 (e.g., microprocessors, ASICs, FPGAs, GPUs, CPUs, processing cores, and/or the like), one or more input/output (I/O) devices and sensors 606, one or more communication interfaces 608 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 610, one or more XR displays 612, one or more optional interior-and/or exterior-facing image sensors 614, a memory 620, and one or more communication buses 604 for interconnecting these and various other components.

In some implementations, the one or more communication buses 604 include circuitry that interconnects and controls communications between system components. In some implementations, the one or more I/O devices and sensors 606 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 612 are configured to present XR content to the user. In some implementations, the one or more XR displays 612 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 612 correspond to diffractive, reflective, polarized, holographic, etc. waveguide displays. For example, the electronic device 600 includes a single XR display. In another example, the electronic device 600 includes an XR display for each eye of the user. In some implementations, the one or more XR displays 612 are capable of presenting AR, MR, and/or VR content.

In various implementations, the one or more XR displays 612 are video passthrough displays which display at least a portion of a real scene as an image captured by a scene camera. In various implementations, the one or more XR displays 612 are optical see-through displays which are at least partially transparent and pass light emitted by or reflected off the real scene.

In some implementations, the one or more image sensors 614 are configured to obtain image data that corresponds to at least a portion of the face of the user that includes the eyes of the user (any may be referred to as an eye-tracking camera). In some implementations, the one or more image sensors 614 are configured to be forward-facing so as to obtain image data that corresponds to the physical environment as would be viewed by the user if the electronic device 600 was not present (and may be referred to as a scene camera). The one or more optional image sensors 614 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 620 includes high-speed random-access memory, such as DRAM, SRAM, DDR RAM, or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 comprises a non-transitory computer readable storage medium. In some implementations, the memory 620 or the non-transitory computer readable storage medium of the memory 620 stores the following programs, modules and data structures, or a subset thereof including an optional operating system 630 and an XR presentation module 640.

The operating system 630 includes procedures for handling various basic system services and for performing hardware dependent tasks. In some implementations, the XR presentation module 640 is configured to present XR content to the user via the one or more XR displays 612. To that end, in various implementations, the XR presentation module 640 includes a data obtaining unit 642, an object associating unit 644, an XR presenting unit 646, and a data transmitting unit 648.

In some implementations, the data obtaining unit 642 is configured to obtain data (e.g., presentation data, interaction data, sensor data, location data, etc.). The data may be obtained from the one or more processing units 602 or another electronic device. To that end, in various implementations, the data obtaining unit 642 includes instructions and/or logic therefor, and heuristics and metadata therefor.

In some implementations, the object associating unit 644 is configured to store associations between enrolled objects and portions of an image of a physical environment. To that end, in various implementations, the object associating unit 644 includes instructions and/or logic therefor, and heuristics and metadata therefor.

In some implementations, the XR presenting unit 646 is configured to present XR content via the one or more XR displays 612 and/or one or more speakers. For example, in various implementations, the XR presenting unit 646 displays the image of the physical environment and one or more anchors. To that end, in various implementations, the XR presenting unit 646 includes instructions and/or logic therefor, and heuristics and metadata therefor.

In some implementations, the data transmitting unit 648 is configured to transmit data (e.g., presentation data, location data, etc.) to the one or more processing units 602, the memory 620, or another electronic device. For example, in various implementations, the data transmitting unit 648 is configured to transmit a command to an enrolled object to change state in response to a user input directed to an associated portion of the image of the physical environment. To that end, in various implementations, the data transmitting unit 648 includes instructions and/or logic therefor, and heuristics and metadata therefor.

Although the data obtaining unit 642, the object associating unit 644, the XR presenting unit 646, and the data transmitting unit 648 are shown as residing on a single electronic device 600, it should be understood that in other implementations, any combination of the data obtaining unit 642, the object associating unit 644, the XR presenting unit 646, and the data transmitting unit 648 may be located in separate computing devices.

Moreover, FIG. 6 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 6 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device including a display, non-transitory memory, and one or more processors:
obtaining an image of a physical environment including a plurality of objects;
generating a respective plurality of associations between the plurality of objects and a plurality of portions of the image of the physical environment;
saving, in the non-transitory memory, the image of the physical environment and the plurality of associations;
displaying the image of the physical environment; and
in response to receiving user input directed to a particular portion of the image of the physical environment of the plurality of portions of the image of the physical environment, causing a change in state of a particular object of the plurality of objects associated with the particular portion of the image of the physical environment by a particular association of the plurality of associations.

2. The method of claim 1, wherein obtaining the image of the physical environment includes:
automatically capturing a plurality of images of the physical environment; and
generating the image of the physical environment based on the plurality of images of the physical environment.

3. The method of claim 2, wherein generating the image of the physical environment includes selecting the image of the physical environment from the plurality of images of the physical environment.

4. The method of claim 2, wherein generating the image of the physical environment includes combining two or more of the plurality of images of the physical environment.

5. The method of claim 1, wherein generating the particular association is based on a user input directed to a location of the image of the physical environment.

6. The method of claim 1, wherein generating the particular association is based on an object model of the particular object.

7. The method of claim 1, wherein generating the particular association includes transmitting one or more commands to the particular object to change a state of the particular object.

8. The method of claim 1, wherein the particular portion of the image of the physical environment is at a location of the particular object in the image of the physical environment.

9. The method of claim 1, wherein the particular portion of the image of the physical environment is at a location a distance from the particular object in the image of the physical environment.

10. The method of claim 1, wherein displaying the image of the physical environment is performed while the device is within the physical environment.

11. The method of claim 1, wherein displaying the image of the physical environment is performed while the device is outside the physical environment.

12. The method of claim 1, further comprising, before displaying the image of the physical environment, moving the device from within the physical environment to outside the physical environment.

13. The method of claim 1, further comprising, before displaying the image of the physical environment, ceasing display of the image of the physical environment.

14. The method of claim 1, wherein displaying the image of the physical environment includes displaying a respective plurality of anchors over the plurality of portions of the image of the physical environment.

15. The method of claim 1, further comprising, while displaying the image of the physical environment, receiving a user input generating a new association between a new object and a new portion of the image of the physical environment.

16. The method of claim 1, wherein causing the change in state of the particular object includes displaying one or more controls for changing one or more states of the particular object.

17. The method of claim 1, wherein causing the change in state of the particular object includes causing a change in state of multiple objects of the plurality of objects.

18. The method of claim 1, further comprising, after causing the change in state of the particular object, displaying an updated image of the physical environment based on the change in state of the particular object.

19. A device comprising:
a display;
a non-transitory memory; and
one or more processors to:
obtain an image of a physical environment including a plurality of objects;
generate a respective plurality of associations between the plurality of objects and a plurality of portions of the image of the physical environment;
save, in the non-transitory memory, the image of the physical environment and the plurality of associations;
display the image of the physical environment; and
in response to receiving user input directed to a particular portion of the image of the physical environment of the plurality of portions of the image of the physical environment, cause a change in state of a particular object of the plurality of objects associated with the particular portion of the image of the physical environment by a particular association of the plurality of associations.

20. A non-transitory memory storing one or more programs, which, when executed by one or more processors of a device including a display, cause the device to:
obtain an image of a physical environment including a plurality of objects;
generate a respective plurality of associations between the plurality of objects and a plurality of portions of the image of the physical environment;
save, in the non-transitory memory, the image of the physical environment and the plurality of associations;
display the image of the physical environment; and
in response to receiving user input directed to a particular portion of the image of the physical environment of the plurality of portions of the image of the physical environment, cause a change in state of a particular object of the plurality of objects associated with the particular portion of the image of the physical environment by a particular association of the plurality of associations.
